(19) United States
(12) Patent Application Publication
(10) Pub. No.: US 2023/0183570 A1
(43) Pub. Date: Jun. 15, 2023

(54) ETCHANTS FOR MAKING TEXTURED GLASS ARTICLES

(71) Applicant: CORNING INCORPORATED, Corning, NY (US)

(72) Inventors: Xinyu Cao, Shanghai (CN); Ling Chen, Shanghai (CN); Wanghui Chen, Zhejiang (CN); Jiangwei Feng, Ithaca, NY (US); Robert Randall Hancock, JR., Corning, NY (US); Yuhui Jin, Painted Post, NY (US); Aize Li, Painted Post, NY (US); Meng Shang, Painted Post, NY (US)

(21) Appl. No.: 18/076,511

(22) Filed: Dec. 7, 2022

Related U.S. Application Data
(60) Provisional application No. 63/328,465, filed on Apr. 7, 2022.
(60) Provisional application No. 63/289,782, filed on Dec. 15, 2021.

(30) Foreign Application Priority Data
Oct. 17, 2022 (CN) 202211271275.X

(51) Int. Cl. C09K 13/08; C03C 3/097; C03C 15/00

(52) U.S. Cl. CPC C09K 13/08; C03C 3/097; C03C 15/00

(57) ABSTRACT

An etchant comprises: greater than or equal to 20 wt % and less than or equal to 45 wt % ammonium bifluoride; greater than or equal to 0.25 wt % and less than or equal to 10 wt % of a silicon compound; greater than or equal to 5 wt % and less than or equal to 30 wt % hydrochloric acid; greater than or equal to 25 wt % and less than or equal to 60 wt % water; and greater than or equal to 0.5 wt % and less than or equal to 20 wt % of polyhydric alcohol. The silicon compound comprises silica, silica gel, ammonium hexafluorosilicate, potassium hexafluorosilicate, sodium hexafluorosilicate, magnesium hexafluorosilicate, or a combination thereof.

This application claims the benefit of priority of Chinese Application Serial No. 202211271275.X filed on Oct. 17, 2022, and claims benefit of priority to U.S. Provisional Application Ser. No. 63/328,465 filed on Apr. 7, 2022, and U.S. Provisional Application Ser. No. 63/289,782 filed on Dec. 15, 2021, the content of each are relied upon and incorporated herein by reference in their entirety.

### FIELD

The present specification generally relates to etchants and, in particular, to etchants for making textured glass articles having sufficient coverage and micro-uniformity of the surface features thereon.

### TECHNICAL BACKGROUND

Aluminosilicate glass articles may exhibit superior ion-exchangeability and drop performance. Various industries, including the consumer electronics industry, desire reflective materials with the same or similar strength and fracture toughness properties. However, conventional texturing etchants may not produce the coverage and micro-uniformity of the surface features on certain aluminosilicate glass articles necessary to achieve the desired appearance.

Accordingly, a need exists for an alternative etchants to produce aluminosilicate glass articles having sufficient coverage and micro-uniformity of the surface features thereon.

### SUMMARY

According to a first aspect A1, an etchant may comprise: greater than or equal to 20 wt % and less than or equal to 45 wt % ammonium bifluoride; greater than or equal to 0.25 wt % and less than or equal to 10 wt % of a silicon compound, the silicon compound comprising silica, silica gel, ammonium hexafluorosilicate, potassium hexafluorosilicate, sodium hexafluorosilicate, magnesium hexafluorosilicate, or a combination thereof; greater than or equal to 5 wt % and less than or equal to 30 wt % hydrochloric acid; greater than or equal to 25 wt % and less than or equal to 60 wt % water; and greater than or equal to 0.5 wt % and less than or equal to 20 wt % of polyhydric alcohol.

A second aspect A2 includes the etchant according to the first aspect A1, wherein the polyhydric alcohol comprises pentaerythritol, ethylene glycol, 1,2-propanediol, 1,4-butanediol, 1,6-hexanediol, neopentyl glycol, diethylene glycol, dipropylene glycol, trimethylolpropane, glycerol, or a combination thereof.

A third aspect A3 includes the etchant according to the first aspect A1 or second aspect A2, wherein a weight ratio of a sum of the ammonium bifluoride and the silicon compound to a sum of the hydrochloric acid, the water, and the polyhydric alcohol is from 0.3 to 0.9.

A fourth aspect A4 includes the etchant according to the any one of the first through third aspects A1-A3, wherein the etchant comprises greater than or equal to 0.5 wt % and less than or equal to 8 wt % of the silicon compound.

A fifth aspect A5 includes the etchant according to the fourth aspect A4, wherein the etchant comprises greater than or equal to 0.75 wt % and less than or equal to 6 wt % of the silicon compound.

A sixth aspect A6 includes the etchant according to any one of the first through fifth aspects A1-A5, wherein the etchant comprises greater than or equal to 1 wt % and less than or equal to 15 wt % polyhydric alcohol.

A seventh aspect A7 includes the etchant according to the sixth aspect A6, wherein the etchant comprises greater than or equal to 1.5 wt % and less than or equal to 10 wt % polyhydric alcohol.

An eighth aspect A8 includes the etchant according to any one of the first through seventh aspects A1-A7, wherein the etchant comprises greater than or equal to 23 wt % and less than or equal to 43 wt % ammonium bifluoride.

A ninth aspect A9 includes the etchant according to the eighth aspect A8, wherein the etchant comprises greater than or equal to 25 wt % and less than or equal to 40 wt % ammonium bifluoride.

A tenth aspect A10 includes the etchant according to any one of the first through ninth aspects A1-A9, wherein the etchant comprises greater than or equal to 7 wt % and less than or equal to 27 wt % hydrochloric acid.

An eleventh aspect A11 includes the etchant according to the tenth aspect A10, wherein the etchant comprises greater than or equal to 10 wt % and less than or equal to 25 wt % hydrochloric acid.

A twelfth aspect A12 includes the etchant according to any one of the first through eleventh aspects A1-A11, wherein the etchant comprises greater than or equal to 30 wt % and less than or equal to 55 wt % water.

A thirteenth aspect A13 includes the etchant according to the first aspect A1, wherein the etchant comprises: greater than or equal to 25 wt % and less than or equal to 40 wt % ammonium bifluoride; greater than or equal to 0.5 wt % and less than or equal to 4 wt % silica gel; greater than or equal to 13 wt % and less than or equal to 23 wt % hydrochloric acid; greater than or equal to 35 wt % and less than or equal to 55 wt % water; and greater than or equal to 1 wt % and less than or equal to 15 wt % glycerol.

A fourteenth aspect A14 includes the etchant according any one of the first through thirteenth aspects A1-A13, wherein the etchant further comprises greater than or equal to 3 wt % and less than or equal to 30 wt % ammonium fluoride.

A fifteenth aspect A15 includes the etchant according any one of the first through fourteenth aspects A1-A14, wherein the etchant further comprises greater than or equal to 0.25 wt % and less than or equal to 20 wt % of at least one of a sodium salt of a potassium salt.

According to fourteenth sixteenth aspect A16, a method of forming a textured glass article may comprise: submerging an aluminosilicate glass article in an etchant, the etchant comprising: greater than or equal to 20 wt % and less than or equal to 45 wt % ammonium bifluoride; greater than or equal to 0.25 wt % and less than or equal to 10 wt % of silicon compound, the silicon compound comprising silica, silica gel, ammonium hexafluorosilicate, potassium hexafluorosilicate, sodium hexafluorosilicate, magnesium hexafluorosilicate, or a combination thereof; greater than or equal to 5 wt % and less than or equal to 30 wt % hydrochloric acid; greater than or equal to 25 wt % and less than or equal to 60 wt % water; and greater than or equal to 0.5 wt % and less than or equal to 20 wt % of polyhydric alcohol; and cycling the aluminosilicate glass article in the etchant between an upper submerging depth and a lower submerging depth deeper than the upper submerging depth for a cycling time.

A seventeenth aspect A17 includes the method according to the sixteenth aspect A16, wherein the cycling is conducted at a speed of greater than or equal to 5 cm/s and less than or equal to 30 cm/s.

A eighteenth aspect A18 includes the method according to the sixteenth aspect A16 or seventeenth aspect A17, wherein a temperature of the etchant is greater than 10° C. and less than or equal to 30° C.

A nineteenth aspect A19 includes the method according to any one of the sixteenth through eighteenth aspects A16-A18, wherein the cycling time is greater than or equal to 60 s and less than or equal to 600 s.

An twentieth aspect A20 includes the method according to any one of the sixteenth through nineteenth aspects A16-A19, wherein the polyhydric alcohol comprises pentaerythritol, ethylene glycol, 1,2-propanediol, 1,4-butanediol, 1,6-hexanediol, neopentyl glycol, diethylene glycol, dipropylene glycol, trimethylolpropane, glycerol, or a combination thereof.

A twenty-first aspect A21 includes the method according to any one of the sixteenth through twentieth aspects A16-A20, wherein a weight ratio of a sum of the ammonium bifluoride and the silicon compound to a sum of the hydrochloric acid, the water, and the polyhydric alcohol is from 0.3 to 0.6.

A twenty-second aspect A22 includes the method according to any one of the sixteenth through twenty-first aspects A16-A21, wherein the etchant comprises greater than or equal to 0.5 wt % and less than or equal to 8 wt % of the silicon compound.

A twenty-third aspect A23 includes the method according to any one of the sixteenth through twenty-second aspects A16-A22, wherein the etchant comprises greater than or equal to 1 wt % and less than or equal to 17 wt % polyhydric alcohol.

A twenty-fourth aspect A24 includes the method according to any one of the sixteenth through twenty-third aspects A16-A23, wherein the etchant comprises greater than or equal to 23 wt % and less than or equal to 43 wt % ammonium bifluoride.

A twenty-fifth aspect A25 includes the method according to any one of the sixteenth through twenty-fourth aspects A16-A24, wherein the etchant comprises greater than or equal to 7 wt % and less than or equal to 27 wt % hydrochloric acid.

A twenty-sixth aspect A26 includes the method according to any one of the sixteenth through twenty-fifth aspects A16-A25, wherein the etchant comprises greater than or equal to 30 wt % and less than or equal to 55 wt % water.

A twenty-seventh aspect A27 includes the method according to any one of the sixteenth through twenty-sixth aspects A16-A26, wherein the etchant further comprises greater than or equal to 3 wt % and less than or equal to 30 wt % ammonium fluoride.

A twenty-eighth aspect A28 includes the method according to any one of the sixteenth through twenty-seventh aspects A16-A27, wherein the etchant further comprises greater than or equal to 0.25 wt % and less than or equal to 20 wt % of at least one of a sodium salt of a potassium salt.

A twenty-ninth aspect A29 includes the method according to any one of the sixteenth through twenty-eighth aspects A16-A28, wherein the aluminosilicate glass article comprises greater than or equal to 14 mol % Al₂O₃.

A thirtieth aspect A30 includes the method according to any one of the sixteenth through twenty-ninth aspects A16-A29, wherein the aluminosilicate glass article comprises: greater than or equal to 50 mol % and less than or equal to 70 mol % SiO₂; greater than or equal to 10 mol % and less than or equal to 22 mol % Al₂O₃; greater than or equal to 0.5 mol % and less than or equal to 5 mol % P₂O₅; greater than or equal to 0 mol % and less than or equal to 10 mol % B₂O₅; greater than or equal to 0 mol % and less than or equal to 3 mol % MgO; greater than or equal to 0 mol % and less than or equal to 3 mol % ZnO; greater than or equal to 3 mol % and less than or equal to 12 mol % Li₂O; greater than or equal to 4 mol % and less than or equal to 15 mol % Na₂O; greater than or equal to 0 mol % and less than or equal to 2 mol % K₂O; and greater than or equal to 0 mol % and less than or equal to 1 mol % TiO₂.

A thirty-first aspect A31 includes the method according to any one of the sixteenth through thirtieth aspects A16-A30, wherein the textured glass article comprises a plurality of polyhedral surface features extending from a first surface, each of the plurality of polyhedral surface features comprising a base on the first surface, a plurality of facets extending from the first surface, a surface feature size at the base greater than or equal to 50 μm and less than or equal to 300 μm, and a surface feature height greater than or equal to 10 μm and less than or equal to 40 μm, wherein the plurality of facets of each polyhedral surface feature converge toward one another.

A thirty-second aspect A32 includes the method according to any one of the sixteenth through thirtieth aspects A16-A30, wherein the textured glass article comprises a plurality of polyhedral surface features extending from a first surface, each of the plurality of polyhedral surface features comprising a base on the first surface, a plurality of facets extending from the first surface, a surface feature size at the base greater than or equal to 50 μm and less than or equal to 300 μm, and a surface feature height greater than or equal to 8 μm and less than or equal to 40 μm, wherein the plurality of facets of each polyhedral surface feature converge toward one another.

A thirty-third aspect A33 includes the method according to the thirty-first aspect A31 or the thirty-second aspect A32, wherein the plurality of polyhedral surface features comprises triangular pyramids, quadrangular pyramids, or a combination thereof.

A thirty-fourth A34 includes the method according to any one of the thirty-first through thirty-third aspects A31-A33, wherein the plurality of polyhedral surface features comprises a facet angle greater than or equal to 13° and less than or equal to 20°.

A thirty-fifth aspect A35 includes the method according to any one of the thirty-first through thirty-fourth aspects A31-A34, wherein the plurality of polyhedral surface features comprises a surface roughness greater than or equal to 2 μm and less than or equal to 7 μm.

A thirty-sixth aspect A36 includes the method according to any one of the thirty-first through thirty-fourth aspects A31-A34, wherein the plurality of polyhedral surface features comprises a surface roughness greater than or equal to 1 μm and less than or equal to 7 μm.

A thirty-seventh aspect A37 includes the method according to any one of the thirty-first through thirty-sixth aspects A31-A36, wherein the plurality of polyhedral surface features comprise a transmittance greater than or equal to 80% and less than or equal to 95%.

A thirty-eighth aspect A38 includes the method according to any one of the thirty-first through thirty-seventh aspects A31-A37, wherein the plurality of polyhedral surface features comprises a transmittance haze greater than or equal to 95% and less than or equal to 100%.

A thirty-ninth aspect A39 includes the method according to any one of the thirty-first through thirty-eighth aspects A31-A38, wherein the plurality of polyhedral surface features comprises a transmittance haze greater than or equal to 80% and less than or equal to 100%.

A fortieth aspect A40 includes the method according to any one of the thirty-first through thirty-ninth aspects A31-A39, wherein the textured glass article has sufficient coverage and micro-uniformity of the plurality of polyhedral surface features.

According to a forty-first aspect A41, an etchant may comprise: greater than or equal to 3 wt % and less than or equal to 30 wt % ammonium fluoride; greater than or equal to 0.25 wt % and less than or equal to 10 wt % of a silicon compound, the silicon compound comprising silica, silica gel, ammonium hexafluorosilicate, potassium hexafluorosilicate, sodium hexafluorosilicate, magnesium hexafluorosilicate, or a combination thereof greater than or equal to 15 wt % and less than or equal to 45 wt % sulfuric acid; greater than or equal to 25 wt % and less than or equal to 60 wt % water; and greater than or equal to 0.1 wt % and less than or equal to 10 wt % of a viscosity additive.

A forty-second aspect A42 includes the etchant according to the forty-first aspect A41, wherein the viscosity additive comprises sugar, metal gluconate, polydiallydimethylammonium chloride (PDADMAC), or a combination thereof.

A forty-third aspect A43 includes the etchant according to the forty-first aspect A41 or the forty-second aspect A42, wherein the etchant comprises greater than or equal to 0.25 wt % and less than or equal to 8 wt % silicon compound.

A forty-fourth aspect A44 includes the etchant according to the forty-third aspect A43, wherein the etchant comprises greater than or equal to 0.5 wt % and less than or equal to 6 wt % silicon compound.

A forty-fifth aspect A45 includes the etchant according to any one of the forty-first through forty-fourth aspects A41-A44, wherein the etchant comprises greater than or equal to 0.25 wt % and less than or equal to 8 wt % of the viscosity additive.

A forty-sixth aspect A46 includes the etchant according to the forty-fifth aspect A45, wherein the etchant comprises greater than or equal to 0.5 wt % and less than or equal to 6 wt % of the viscosity additive.

A forty-seventh aspect A47 includes the etchant according to any one of the forty-first through forty-sixth aspects A41-A46, wherein the etchant comprises greater than or equal to 5 wt % and less than or equal to 27 wt % ammonium fluoride.

A forty-eighth aspect A48 includes the etchant according to the forty-seventh aspect A47, wherein the etchant comprises greater than or equal to 7 wt % and less than or equal to 25 wt % ammonium fluoride.

A forty-ninth aspect A49 includes the etchant according to any one of the forty-first through forty-eighth aspects A41-A48, wherein the etchant comprises greater than or equal to 17 wt % and less than or equal to 43 wt % sulfuric acid.

A fiftieth aspect A50 includes the etchant according to the forty-ninth aspect A49, wherein the etchant comprises greater than or equal to 20 wt % and less than or equal to 40 wt % sulfuric acid.

A fifty-first aspect A51 includes the etchant according to any one of the forty-first through fiftieth aspects A41-A50, wherein the etchant comprises greater than or equal to 30 wt % and less than or equal to 60 wt % water.

A fifty-second aspect A52 includes the etchant according to the forty-first aspect A41, wherein the etchant comprises: greater than or equal to 10 wt % and less than or equal to 25 wt % ammonium fluoride; greater than or equal to 0.25 wt % and less than or equal to 2 wt % ammonium hexafluorosilicate; greater than or equal to 25 wt % and less than or equal to 40 wt % sulfuric acid; greater than or equal to 40 wt % and less than or equal to 60 wt % water; and greater than or equal to 0.1 wt % and less than or equal to 4 wt % of at least one of sodium gluconate and polydiallydimethylammonium chloride (PDADMAC).

According to a fifty-third aspect A53, a method of forming a textured glass article may comprise: submerging an aluminosilicate glass article in an etchant, the etchant comprising: greater than or equal to 3 wt % and less than or equal to 30 wt % ammonium fluoride; greater than or equal to 0.25 wt % and less than or equal to 10 wt % of a silicon compound, the silicon compound comprising silica, silica gel, ammonium hexafluorosilicate, potassium hexafluorosilicate, sodium hexafluorosilicate, magnesium hexafluorosilicate, or a combination thereof; greater than or equal to 15 wt % and less than or equal to 45 wt % sulfuric acid; greater than or equal to 25 wt % and less than or equal to 60 wt % water; and greater than or equal to 0.1 wt % and less than or equal to 10 wt % of a viscosity additive; and cycling the aluminosilicate glass article in the etchant between an upper submerging depth and a lower submerging depth deeper than the upper submerging depth for a cycling time.

A fifty-fourth aspect A54 includes the method according to the fifty-third aspect A53, wherein the cycling is conducted at a speed of greater than or equal to 3 cm/s and less than or equal to 30 cm/s.

A fifty-fifth aspect A55 includes the method according to the fifty-third aspect A53 or fifty-fourth aspect A54, wherein a temperature of the etchant is greater than 10° C. and less than or equal to 30° C.

A fifty-sixth aspect A56 includes the method according to any one of the fifty-third through fifty-fifth aspects A53-A55, wherein the cycling time is greater than or equal to 30 s and less than or equal to 600 s.

A fifty-seventh aspect A57 includes the method according to any one of the fifty-third through fifty-sixth aspects A53-A56, wherein the viscosity additive comprises sugar, metal gluconate, polydiallydimethylammonium chloride (PDADMAC), or a combination thereof.

A fifty-eighth aspect A58 includes the method according to any one of the fifty-third through fifty-seventh aspect A53-A57, wherein the etchant comprises greater than or equal to 0.25 wt % and less than or equal to 8 wt % silicon compound.

A fifty-ninth aspect A59 includes the method according to any one of the fifty-third through fifty-eighth aspects A53-A58, wherein the etchant comprises greater than or equal to 0.25 wt % and less than or equal to 8 wt % of the viscosity additive.

A sixtieth aspect A60 includes the method according to any one of the fifty-third through fifty-ninth aspects A53-A59, wherein the etchant comprises greater than or equal to 5 wt % and less than or equal to 27 wt % ammonium fluoride.

A sixty-first aspect A61 includes the method according to any one of the fifty-third through sixtieth aspects A53-A60, wherein the etchant comprises greater than or equal to 17 wt % and less than or equal to 43 wt % sulfuric acid.

A sixty-second aspect A62 includes the method according to any one of the fifty-third through sixty-first aspects A53-A61, wherein the etchant comprises greater than or equal to 40 wt % and less than or equal to 60 wt % water.

A sixty-third aspect A63 includes the method according to any one of the fifty-third through sixty-second aspects A53-A62, wherein the aluminosilicate glass article comprises greater than or equal to 14 mol % Al₂O₃.

A sixty-fourth aspect A64 includes the method according to any one of the fifty-third through sixty-third aspects A53-A63, wherein the aluminosilicate glass article comprises: greater than or equal to 50 mol % and less than or equal to 70 mol % SiO₂; greater than or equal to 10 mol % and less than or equal to 22 mol % Al₂O₃; greater than or equal to 0.5 mol % and less than or equal to 5 mol % P₂O₅; greater than or equal to 0 mol % and less than or equal to 10 mol % B₂O₅; greater than or equal to 0 mol % and less than or equal to 3 mol % MgO; greater than or equal to 0 mol % and less than or equal to 3 mol % ZnO; greater than or equal to 4 mol % and less than or equal to 15 mol % Na₂O; greater than or equal to 0 mol % and less than or equal to 2 mol % K₂O; and greater than or equal to 0 mol % and less than or equal to 1 mol % TiO₂.

A sixty-fifth aspect A65 includes the method according to any one of the fifty-third through sixty-fourth aspects A53-A64, wherein the textured glass article comprises a plurality of polyhedral surface features extending from a first surface, each of the plurality of polyhedral surface features comprising a base on the first surface, a plurality of facets extending from the first surface, a surface feature size at the base greater than or equal to 50 μm and less than or equal to 300 μm, wherein the plurality of facets of each polyhedral surface feature converge toward one another.

A sixty-sixth aspect A66 includes the method according to the sixty-fifth aspect A65, wherein the plurality of polyhedral surface features comprises triangular pyramids, quadrangular pyramids, or a combination thereof.

A sixty-seventh aspect A67 includes the method according to any one of the sixty-third through sixty-sixth aspects A63-A66, wherein the textured glass article has sufficient coverage and micro-uniformity of the plurality of polyhedral surface features.

Additional features and advantages of the etchants described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an etchant reacting with an aluminosilicate glass article, according to one or more embodiments shown or described herein;

FIG. 2 is a flow diagram of a method of forming a textured glass article, according to one or more embodiments shown and described herein;

FIG. 3 schematically depicts a step of the method of forming a textured glass article, according to one or more embodiments shown and described herein;

FIG. 4 schematically depicts another step of the method of forming a textured glass article, according to one or more embodiments shown and described herein;

FIG. 5 schematically depicts another step of the method of forming a textured glass article, according to one or more embodiments shown and described herein;

FIG. 6 schematically depicts a plan view of a textured glass article, according to one or more embodiments shown and described herein;

FIG. 7 schematically depicts a plan view of a polyhedral surface feature, according to one or more embodiments shown and described herein;

FIG. 8 schematically depicts a plan view of another polyhedral surface feature, according to one or more embodiments shown and described herein;

FIG. 9 is a plan view of an exemplary electronic device incorporating any of the textured glass articles, according to one or more embodiments shown and described herein;

FIG. 10 is a perspective view of the exemplary electronic device of FIG. 9;

FIG. 11 is a perspective view of the exemplary electronic device of FIG. 9;

FIG. 12 is an optical microscope image with a magnification of 100× of a textured glass article, according to one or more embodiments shown and described herein;

FIG. 13 is an optical microscope image with a magnification of 100× of another textured glass article, according to one or more embodiments shown and described herein;

FIG. 14 is an optical microscope image with a magnification of 100× of another textured glass article, according to one or more embodiments shown and described herein;

FIG. 15 is an optical microscope image with a magnification of 100× of another textured glass article, according to one or more embodiments shown and described herein;

FIG. 16 is an optical microscope image with a magnification of 100× of another textured glass article, according to one or more embodiments shown and described herein;

FIG. 17 is an optical microscope image with a magnification of 100× of another textured glass article, according to one or more embodiments shown and described herein;

FIG. 18 is an optical microscope image with a magnification of 100× of another textured glass article, according to one or more embodiments shown and described herein;

FIG. 19 is an optical microscope image with a magnification of 50× of a comparative textured glass article;

FIG. 20 is an optical microscope image with a magnification of 50× of another textured glass article, according to one or more embodiments shown and described herein;

FIG. 21 is an optical microscope image with a magnification of 50× of another textured glass article, according to one or more embodiments shown and described herein; and

FIG. 22 is an optical microscope image with a magnification of 50× of another textured glass article, according to one or more embodiments shown and described herein.

### DETAILED DESCRIPTION

Reference will now be made in detail to various embodiments of etchants used to form textured glass articles having sufficient coverage and micro-uniformity of the polyhedral surface features thereon. According to embodiments, an etchant comprises: greater than or equal to 20 wt % and less than or equal to 45 wt % ammonium bifluoride; greater than or equal to 0.25 wt % and less than or equal to 10 wt % of a silicon compound; greater than or equal to 5 wt % and less than or equal to 30 wt % hydrochloric acid; greater than or equal to 25 wt % and less than or equal to 60 wt % water; and greater than or equal to 0.5 wt % and less than or equal to 20 wt % of polyhydric alcohol. The silicon compound comprises silica, silica gel, ammonium hexafluorosilicate, potassium hexafluorosilicate, sodium hexafluorosilicate, magnesium hexafluorosilicate, or a combination thereof.

According to other embodiments, an etchant comprises greater than or equal to 3 wt % and less than or equal to 30 wt % ammonium fluoride; greater than or equal to 0.25 wt % and less than or equal to 10 wt % of a silicon compound; greater than or equal to 15 wt % and less than or equal to 45 wt % sulfuric acid; greater than or equal to 25 wt % and less than or equal to 75 wt % water; and greater than or equal to 0.1 wt % and less than or equal to 10 wt % of a viscosity additive. The silicon compound comprises silica, silica gel, ammonium hexafluorosilicate, potassium hexafluorosilicate, sodium hexafluorosilicate, magnesium hexafluorosilicate, or a combination thereof.

Various embodiments of etchants and methods of forming textured glass articles will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply ab solute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the aluminosilicate glass articles described herein, the concentrations of constituent components (e.g., SiO₂, Al₂O₃, and the like) are specified in mole percent (mol %) on an oxide basis, unless otherwise specified.

Optical microscope images, as described herein, are obtained using Nikon Eclipse L200N optical microscope with 10× objectives and multiple 10× from eyepiece for a total magnification of 100×.

“Surface feature size,” as described herein, is measured using optical microscopy at 200× magnification. Images are obtained of two different 500 μm×1000 μm scanned areas. In each image, the maximum distance across the cross section of the base of the 10 largest surface features is measured. “Surface feature size” refers to the average maximum distance across the cross section of the base of the 20 surface features from the two scanned areas. For example, for surface features with a triangular base, the maximum distance across the cross section of the base is the height of the triangular base. For surface features with a rectangular base, the maximum distance across the cross section of the base is the diagonal measurement across the base.

“Surface feature height,” as described herein, refers to the average polyhedral surface feature distance between the base of the surface feature and the topmost apex of the surface feature.

“Facet angle,” as described herein, refers to the average polyhedral surface angle between a plane normal to a first surface of the aluminosilicate glass article and the facet. The facet angle is measured by arctan (height/half length) of the surface feature. “Triangular pyramid facet angle,” as used herein, refers to the average facet angle of the triangular pyramids present on the aluminosilicate glass article. “Quadrangular pyramid facet angle,” as used herein, refers to the average facet angle of the quadrangular pyramids present on the aluminosilicate glass article.

“Surface roughness,” as described herein, refers to the surface texture of a textured glass article quantified by the arithmetic average of the absolute values of the profile height deviations from the mean line, recorded within the evaluation length, as measured by a Mitutoyo SJ-310 surface roughness meter and in accordance with ISO1997. Values reported herein are reported in microns, or μm, unless otherwise expressly stated.

“Transmittance,” as described herein, refers to the average ratio of incident light which is transmitted within a given wavelength range. “Transmittance,” as described herein, is measured in accordance with ASTM D1003 with a BYK Hazeguard with a wavelength range of 380 nm to 720 nm at a thickness of 0.8 mm, unless otherwise indicated.

“Transmittance haze,” as described herein, refers to the ratio of transmitted light scattered at an angle greater than 2.5° from normal to all transmitted light over the total transmission. Transmittance haze, as described herein, is measured in accordance with ASTM D1003 with a standard CIE-C illuminant with a wavelength range of 380 nm to 720 nm at a thickness of 0.8 mm, unless otherwise indicated.

“Sufficient coverage,” when used herein to describe the plurality of polyhedral surface features of the textured glass article, refers to the polyhedral surface features covering greater than or equal to 90% of a major surface of the textured glass article.

“Micro-uniformity,” when used herein to describe the plurality of polyhedral surface features of the textured glass article, refers to the individual feature sizes not varying more than 20%.

“Polyhedral,” when used to describe the structure of a surface feature on a textured glass article, refers to a three-dimensional shape with flat polygonal faces and straight edges.

“Dendritic,” when used to describe the structure of a surface feature on a textured glass article, refers to a branching structure.

Etchants have been used to achieve textured surfaces on glass articles. Properties of the textured surfaces, including the structure, size, coverage, and micro-uniformity of the surface features may effect the appearance (e.g., reflectivity or “glowing effect”) of the textured glass article. Due to their flat polygonal faces and straight edges, polyhedral surface features may achieve a better “glowing effect” than dendritic surface features. While conventional texturing etchants may result in polyhedral surface features, such etchants may not result in the coverage and micro-uniformity of the polyhedral surface features necessary to achieve the desired appearance.

Disclosed herein are etchants and methods of forming textured glass articles which mitigate the aforementioned problems such that aluminosilicate glasses may be treated to have sufficient coverage and micro-uniformity of polyhedral surface features thereon. Specifically, to achieve sufficient coverage and micro-uniformity of surface features to produce the desired “glowing effect,” the etchants described herein are prepared such that the etchant preferentially generates a silicon-based precipitate and minimizes the amount of aluminum based-precipitate. Silicon-based precipitates (e.g., metal fluorosilicate (MSiF₆)) lead to large, polyhedral surface features, which reflect more light than dendritic surface features. Aluminum-based precipitates (e.g., metal aluminofluoride (MAlF₅)) lead to small, dendritic surface features. Accordingly, in embodiments, the etchant comprises ammonium bifluoride, a silicon compound, polyhydric alcohol, hydrochloric acid, and water. In other embodiments, the etchant comprises ammonium fluoride, a silicon compound, a viscosity additive, sulfuric acid, and water.

Ammonium Bifluoride and/or Ammonium Fluoride

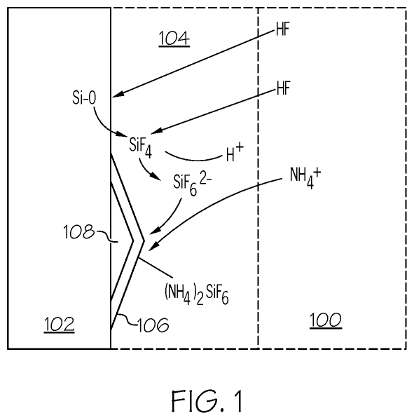

Referring now to FIG. 1, the ammonium bifluoride includes hydrogen fluoride (HF) species and ammonium (NH₄) ions. The etchant 100 reacts with the aluminosilicate glass article 102, which causes HF species from the etchant 100 to diffuse into the aluminosilicate glass article 102 and corrode the Si—O network. SiF₄ is released from the aluminosilicate glass article 102 and reacts with HF to generate SiF₆²⁻ ions. The NH₄ ions from the etchant 100 diffuse to an interface 104 of the etchant 100 and aluminosilicate glass article 102 and react with the SiF₆²⁻ ions to produce ammonium fluorosilicate ((NH₄)₂SiF₆ precipitates. Because these precipitates have low solubility in the etchant 100, they then deposit on the surface of the aluminosilicate glass article 102 to form crystal seeds 106 (e.g., salt crusts).

As the etchant 100 continues to react with the aluminosilicate glass article 102, the crystal seeds 106 grow. Because the crystal seeds 106 are insoluble in the etchant, the crystal seeds 106 serve as an in-situ mask. The crystal seeds 106 seal portions of the surface of the aluminosilicate glass article 102. Glass is etched away around the crystal seeds 106 to generate polyhedral surface features 108. The shape of the polyhedral surface features 108 may be determined by the shape of the crystal seeds 106, which may be altered by varying the composition of the etchant 100 and/or varying the length of time the etchant contacts the aluminosilicate glass article 102.

As such, the ammonium bifluoride present in the etchant 100 acts as a crystallization promoter, encouraging the formation of crystal seeds 106. The amount of ammonium bifluoride in the etchant 100 should be sufficiently high (e.g., greater than or equal to 20 wt %) to ensure formation of the crystal seeds 106. The amount of ammonium bifluoride may be limited (less than or equal to 45 wt %) to reduce or prevent undissolved salt that may precipitate out once solubility is reached. Undissolved salt may etch differently than the etchant and may cause a lack of micro-uniformity.

In embodiments, the etchant 100 may comprise greater than or equal to 20 wt % and less than or equal to 45 wt % ammonium bifluoride. In embodiments, the etchant 100 may comprise greater than or equal to 23 wt % and less than or equal to 43 wt % ammonium bifluoride. In embodiments, the etchant 100 may comprise greater than or equal to 25 wt % and less than or equal to 41 wt % ammonium bifluoride. In embodiments, the amount of ammonium bifluoride in the etchant 100 may be greater than or equal to 20 wt %, greater than or equal to 23 wt %, greater than or equal to 25 wt %, or even greater than or equal to 27 wt %. In embodiments, the amount of ammonium biflouride in the etchant 100 may be less than or equal to 45 wt %, less than or equal to 43 wt %, less than or equal to 40 wt %, less than or equal to 37 wt %, or even less than or equal to 35 wt %. In embodiments, the amount of ammonium bifluoride in the etchant 100 may be greater than or equal to 20 wt % and less than or equal to 45 wt %, greater than or equal to 20 wt % and less than or equal to 43 wt %, greater than or equal to 20 wt % and less than or equal to 40 wt %, greater than or equal to 20 wt % and less than or equal to 37 wt %, greater than or equal to 20 wt % and less than or equal to 35 wt %, greater than or equal to 23 wt % and less than or equal to 45 wt %, greater than or equal to 23 wt % and less than or equal to 43 wt %, greater than or equal to 23 wt % and less than or equal to 40 wt %, greater than or equal to 23 wt % and less than or equal to 37 wt %, greater than or equal to 23 wt % and less than or equal to 35 wt %, greater than or equal to 25 wt % and less than or equal to 45 wt %, greater than or equal to 25 wt % and less than or equal to 43 wt %, greater than or equal to 25 wt % and less than or equal to 40 wt %, greater than or equal to 25 wt % and less than or equal to 37 wt %, greater than or equal to 25 wt % and less than or equal to 35 wt %, greater than or equal to 27 wt % and less than or equal to 45 wt %, greater than or equal to 27 wt % and less than or equal to 43 wt %, greater than or equal to 27 wt % and less than or equal to 40 wt %, greater than or equal to 27 wt % and less than or equal to 37 wt %, or even greater than or equal to 27 wt % and less than or equal to 35 wt %, or any and all sub-ranges formed from any of these endpoints.

In embodiments, in addition to or as an alternative for ammonium bifluoride, the etchant 100 may comprise ammonium fluoride. Similar to ammonium bifluoride, ammonium fluoride is a source of hydrogen fluoride (HF) species and ammonium (NH₄) ions and acts as a crystallization promoter, encouraging the formation of crystal seeds. The amount of ammonium fluoride should be sufficiently high (e.g., greater than or equal to 3 wt %) to ensure formation of the crystal seeds 106. The amount of ammonium fluoride may be limited (less than or equal to 30 wt %) to reduce or prevent undissolved salt that may precipitate out once solubility is reached. Undissolved salt may etch differently than the etchant and may cause a lack of micro-uniformity.

In embodiments, the etchant 100 may comprise greater than or equal to 3 wt % and less than or equal to 30 wt % ammonium fluoride. In embodiments, the etchant 100 may comprise greater than or equal to 5 wt % and less than or equal to 27 wt % ammonium fluoride. In embodiments, the etchant 100 may comprise greater than or equal to 7 wt % and less than or equal to 25 wt % ammonium fluoride. In embodiments, the etchant 100 may comprise greater than or equal to 10 wt % and less than or equal to 25 wt % ammonium fluoride. In embodiments, the amount of ammonium fluoride in the etchant 100 may be greater than or equal to 2 wt %, greater than or equal to 7 wt %, greater than or equal to 10 wt %, greater than or equal to 13 wt %, or even greater than or equal to 15 wt %. In embodiments, the amount of ammonium fluoride in the etchant 100 may be less than or equal to 30 wt %, less than or equal to 27 wt %, less than or equal to 25 wt %, less than or equal to 23 wt %, less than or equal to 20 wt %, less than or equal to 17 wt %, less than or equal to 15 wt %, less than or equal to 13 wt %, or even less than or equal to 10 wt %. In embodiments, the amount of ammonium fluoride in the etchant 100 may be greater than or equal to 3 wt % and less than or equal to 30 wt %, greater than or equal to 3 wt % and less than or equal to 27 wt %, greater than or equal to 3 wt % and less than or equal to 25 wt %, greater than or equal to 3 wt % and less than or equal to 23 wt %, greater than or equal to 3 wt % and less than or equal to 20 wt %, greater than or equal to 3 wt % and less than or equal to 17 wt %, greater than or equal to 3 wt % and less than or equal to 15 wt %, greater than or equal to 3 wt % and less than or equal to 13 wt %, greater than or equal to 3 wt % and less than or equal to 10 wt %, greater than or equal to 5 wt % and less than or equal to 30 wt %, greater than or equal to 5 wt % and less than or equal to 27 wt %, greater than or equal to 5 wt % and less than or equal to 25 wt %, greater than or equal to 5 wt % and less than or equal to 23 wt %, greater than or equal to 5 wt % and less than or equal to 20 wt %, greater than or equal to 5 wt % and less than or equal to 17 wt %, greater than or equal to 5 wt % and less than or equal to 15 wt %, greater than or equal to 5 wt % and less than or equal to 13 wt %, greater than or equal to 5 wt % and less than or equal to 10 wt %, greater than or equal to 7 wt % and less than or equal to 30 wt %, greater than or equal to 7 wt % and less than or equal to 27 wt %, greater than or equal to 7 wt % and less than or equal to 25 wt %, greater than or equal to 7 wt % and less than or equal to 23 wt %, greater than or equal to 7 wt % and less than or equal to 20 wt %, greater than or equal to 7 wt % and less than or equal to 17 wt %, greater than or equal to 7 wt % and less than or equal to 15 wt %, greater than or equal to 7 wt % and less than or equal to 13 wt %, greater than or equal to 7 wt % and less than or equal to 10 wt %, greater than or equal to 10 wt % and less than or equal to 30 wt %, greater than or equal to 10 wt % and less than or equal to 27 wt %, greater than or equal to 10 wt % and less than or equal to 25 wt %, greater than or equal to 10 wt % and less than or equal to 23 wt %, greater than or equal to 10 wt % and less than or equal to 20 wt %, greater than or equal to 10 wt % and less than or equal to 17 wt %, greater than or equal to 10 wt % and less than or equal to 15 wt %, greater than or equal to 10 wt % and less than or equal to 13 wt %, greater than or equal to 13 wt % and less than or equal to 30 wt %, greater than or equal to 13 wt % and less than or equal to 27 wt %, greater than or equal to 13 wt % and less than or equal to 25 wt %, greater than or equal to 13 wt % and less than or equal to 23 wt %, greater than or equal to 13 wt % and less than or equal to 20 wt %, greater than or equal to 13 wt % and less than or equal to 17 wt %, greater than or equal to 13 wt % and less than or equal to 15 wt %, greater than or equal to 15 wt % and less than or equal to 30 wt %, greater than or equal to 15 wt % and less than or equal to 27 wt %, greater than or equal to 15 wt % and less than or equal to 25 wt %, greater than or equal to 15 wt % and less than or equal to 23 wt %, greater than or equal to 15 wt % and less than or equal to 20 wt %, or even greater than or equal to 15 wt % and less than or equal to 17 wt %, or any and all sub-ranges formed from any of these endpoints.

In embodiments in which the etchant 100 comprises ammonium bifluoride, the amount of ammonium fluoride in the etchant 100 may be greater than or equal to 3 wt % and less than or equal to 30 wt %, greater than or equal to 3 wt % and less than or equal to 27 wt %, greater than or equal to 3 wt % and less than or equal to 25 wt %, greater than or equal to 3 wt % and less than or equal to 23 wt %, greater than or equal to 3 wt % and less than or equal to 20 wt %, greater than or equal to 3 wt % and less than or equal to 17 wt %, greater than or equal to 3 wt % and less than or equal to 15 wt %, greater than or equal to 3 wt % and less than or equal to 13 wt %, greater than or equal to 3 wt % and less than or equal to 10 wt %, greater than or equal to 5 wt % and less than or equal to 30 wt %, greater than or equal to 5 wt % and less than or equal to 27 wt %, greater than or equal to 5 wt % and less than or equal to 25 wt %, greater than or equal to 5 wt % and less than or equal to 23 wt %, greater than or equal to 5 wt % and less than or equal to 20 wt %, greater than or equal to 5 wt % and less than or equal to 17 wt %, greater than or equal to 5 wt % and less than or equal to 15 wt %, greater than or equal to 5 wt % and less than or equal to 13 wt %, greater than or equal to 5 wt % and less than or equal to 10 wt %, or any and all sub-ranges formed from any of these endpoints.

In embodiments in which the etchant 100 does not comprise ammonium bifluoride, the amount of ammonium fluoride in the etchant 100 may be greater than or equal to 3 wt % and less than or equal to 30 wt %, greater than or equal to 3 wt % and less than or equal to 27 wt %, greater than or equal to 3 wt % and less than or equal to 25 wt %, greater than or equal to 3 wt % and less than or equal to 23 wt %, greater than or equal to 3 wt % and less than or equal to 20 wt %, greater than or equal to 5 wt % and less than or equal to 30 wt %, greater than or equal to 5 wt % and less than or equal to 27 wt %, greater than or equal to 5 wt % and less than or equal to 25 wt %, greater than or equal to 5 wt % and less than or equal to 23 wt %, greater than or equal to 5 wt % and less than or equal to 20 wt %, greater than or equal to 7 wt % and less than or equal to 30 wt %, greater than or equal to 7 wt % and less than or equal to 27 wt %, greater than or equal to 7 wt % and less than or equal to 25 wt %, greater than or equal to 7 wt % and less than or equal to 23 wt %, greater than or equal to 7 wt % and less than or equal to 20 wt %, greater than or equal to 10 wt % and less than or equal to 30 wt %, greater than or equal to 10 wt % and less than or equal to 27 wt %, greater than or equal to 10 wt % and less than or equal to 25 wt %, greater than or equal to 10 wt % and less than or equal to 23 wt %, greater than or equal to 10 wt % and less than or equal to 20 wt %, greater than or equal to 13 wt % and less than or equal to 30 wt %, greater than or equal to 13 wt % and less than or equal to 27 wt %, greater than or equal to 13 wt % and less than or equal to 25 wt %, greater than or equal to 13 wt % and less than or equal to 23 wt %, greater than or equal to 13 wt % and less than or equal to 20 wt %, greater than or equal to 15 wt % and less than or equal to 30 wt %, greater than or equal to 15 wt % and less than or equal to 27 wt %, greater than or equal to 15 wt % and less than or equal to 25 wt %, greater than or equal to 15 wt % and less than or equal to 23 wt %, or even greater than or equal to 15 wt % and less than or equal to 20 wt %, or any and all sub-ranges formed from any of these endpoints.

Silicon Compound

The silicon compound in the etchant 100 may be used to increase the concentration of Si ions (e.g., silica and silica gel) or the concentration of SiF₆ ions (e.g., ammonium hexafluorosilicate, potassium hexafluorosilicate, sodium hexafluorosilicate, or magnesium hexafluorosilicate), thereby speeding up the precipitation of ammonium fluorosilicate on the aluminosilicate glass article 102. In embodiments, the silicon compound may comprise silica, silica gel, ammonium hexaflurosilicate, potassium hexafluorosilicate, sodium hexafluorosilicate, magnesium hexafluorosilicate, or a combination thereof.

The amount of silicon compound in the etchant 100 should be sufficiently high (e.g., greater than or equal to 0.25 wt %) to ensure that the concentration of Si or SiF₆ ions is increased. The amount of silicon compound may be limited (e.g., less than or equal to 10 wt %) so as to not increase the viscosity of the etchant 100 to a point where sufficient coverage and micro-uniformity of the resulting polyhedral surface features are not achieved.

In embodiments, the etchant 100 may comprise greater than or equal to 0.25 wt % and less than or equal to 10 wt % of the silicon compound. In embodiments, the etchant 100 may comprise greater than or equal to 0.5 wt % and less than or equal to 8 wt % of the silicon compound. In embodiments, the etchant 100 may comprise greater than or equal to 0.75 wt % and less than or equal to 6 wt % of the silicon compound. In embodiments, the amount of the silicon compound in the etchant 100 may be greater than or equal to 0.25 wt %, greater than or equal to 0.5 wt %, greater than or equal 0.75 wt %, or even greater than or equal to 1 wt %. In embodiments, the amount of silicon compound in the etchant 100 may be less than or equal to 10 wt %, less than or equal to 8 wt %, less than or equal to 6 wt %, or even less than or equal to 4 wt %. In embodiments, the amount of the silicon compound in the etchant 100 may be greater than or equal to 0.25 wt % and less than or equal to 10 wt %, greater than or equal to 0.25 wt % and less than or equal to 8 wt %, greater than or equal to 0.25 wt % and less than or equal to 6 wt %, greater than or equal to 0.25 wt % and less than or equal to 4 wt %, greater than or equal to 0.5 wt % and less than or equal to 10 wt %, greater than or equal to 0.5 wt % and less than or equal to 8 wt %, greater than or equal to 0.5 wt % and less than or equal to 6 wt %, greater than or equal to 0.5 wt % and less than or equal to 4 wt %, greater than or equal to 0.75 wt % and less than or equal to 10 wt %, greater than or equal to 0.75 wt % and less than or equal to 8 wt %, greater than or equal to 0.75 wt % and less than or equal to 6 wt %, greater than or equal to 0.75 wt % and less than or equal to 4 wt %, greater than or equal to 1 wt % and less than or equal to 10 wt %, greater than or equal to 1 wt % and less than or equal to 8 wt %, greater than or equal to 1 wt % and less than or equal to 6 wt %, or even greater than or equal to 1 wt % and less than or equal to 4 wt %, or any and all sub-ranges formed from any of these endpoints.

Polyhydric Alcohol or Viscosity Additive

Polyhydric alcohol may be used in the etchant 100 to increase the viscosity of the etchant to help regulate the flow of the etchant. Polyhydric alcohol may also be used in the etchant 100 to decrease the dissolvability of ammonium fluorosilicate, thereby increasing the precipitation of ammonium fluorosilicate. In embodiments, the polyhydric alcohol may comprise pentaerythritol, ethylene glycol, 1,2-propanediol, 1,4-butanediol, 1,6-hexanediol, neopentyl glycol, diethylene glycol, dipropylene glycol, trimethylolpropane, glycerol, or a combination thereof.

The amount of polyhydric alcohol in the etchant 100 should be sufficiently high (e.g., greater than or equal to 0.5 wt %) to ensure increased etchant viscosity. The amount of polyhydric alcohol may be limited (e.g., less than or equal to 20 wt %) so as to not increase the viscosity of the etchant 100 to a point were sufficient coverage and micro-uniformity of the resulting polyhedral surface features are not achieved. In embodiments, the etchant 100 may comprise greater than or equal to 0.5 wt % and less than or equal to 20 wt % of polyhydric alcohol. In embodiments, the etchant 100 may comprise greater than or equal to 1 wt % and less than or equal to 15 wt % polyhydric alcohol. In embodiments, the etchant 100 may comprise greater than or equal to 1.5 wt % and less than or equal to 10 wt % polyhydric alcohol. In embodiments, the amount of polyhydric alcohol in the etchant 100 may be greater than or equal to 0.5 wt %, greater than or equal to 1 wt %, greater than or equal to 1.5 wt %, or even greater than or equal to 2 wt %. In embodiments, the amount of polyhydric alcohol in the etchant 100 may be less than or equal to 20 wt %, less than or equal to 15 wt %, less than or equal to 10 wt %, or even less than or equal to 5 wt %. In embodiments, the amount of polyhydric alcohol in the etchant 100 may be greater than or equal to 0.5 wt % and less than or equal to 20 wt %, greater than or equal to 0.5 wt % and less than or equal to 15 wt %, greater than or equal to 0.5 wt % and less than or equal to 10 wt %, greater than or equal to 0.5 wt % and less than or equal to 5 wt %, greater than or equal to 1 wt % and less than or equal to 20 wt %, greater than or equal to 1 wt % and less than or equal to 15 wt %, greater than or equal to 1 wt % and less than or equal to 10 wt %, greater than or equal to 1 wt % and less than or equal to 5 wt %, greater than or equal to 1.5 wt % and less than or equal to 20 wt %, greater than or equal to 1.5 wt % and less than or equal to 15 wt %, greater than or equal to 1.5 wt % and less than or equal to 10 wt %, greater than or equal to 1.5 wt % and less than or equal to 5 wt %, greater than or equal to 2 wt % and less than or equal to 20 wt %, greater than or equal to 2 wt % and less than or equal to 15 wt %, greater than or equal to 2 wt % and less than or equal to 10 wt %, or even greater than or equal to 2 wt % and less than or equal to 5 wt %, or any and all sub-ranges formed from any of these endpoints.

As an alternative to the polyhydric alcohol, in embodiments, a viscosity additive may be used to increase the viscosity of the etchant to help regulate the flow of the etchant. In embodiments, the viscosity additive may comprise sugar, metal gluconate, polydiallydimethylammonium chloride (PDADMAC), or a combination thereof. In embodiments, the metal gluconate may comprise sodium gluconate, lithium gluconate, potassium gluconate, calcium gluconate, gluconic acid, or a combination thereof. In embodiments, the sugar may comprise glucose, sucrose, fructose, or a combination thereof. In embodiments, the viscosity additive may comprise at least one of sodium gluconoate and PDADMAC. The amount of the viscosity additive should be sufficiently high (e.g., greater than or equal to 0.1 wt %) to ensure increased etchant viscosity. The amount of the viscosity additive may be limited (e.g., less than or equal to 10) so as to not increase the viscosity of the etchant 100 to a point where sufficient coverage and micro-uniformity of the resulting polyhedral surface features are not achieved.

In embodiments, the etchant 100 may comprise greater than or equal to 0.1 wt % and less than or equal to 10 wt % of the viscosity additive. In embodiments, the etchant 100 may comprise greater than or equal to 0.25 wt % and less than or equal to 8 wt % of the viscosity additive. In embodiments, the etchant 100 may comprise greater than or equal to 0.5 wt % and less than or equal to 6 wt % of the viscosity additive. In embodiments, the etchant 100 may comprise greater than or equal to 0.1 wt % and less than or equal to 4 wt % of the viscosity additive. In embodiments, the amount of the viscosity additive in the etchant 100 may be greater than or equal to 0.1 wt %, greater than or equal to 0.25 wt %, greater than or equal to 0.5 wt %, greater than or equal to 0.75 wt %, or even greater than or equal to 1 wt %. In embodiments, the amount of the viscosity additive in the etchant 100 may be less than or equal to 10 wt %, less than or equal to 8 wt %, less than or equal to 6 wt %, less than or equal to 4 wt %, or even less than or equal to 2 wt %. In embodiments, the amount of the viscosity additive in the etchant 100 may be greater than or equal to 0.1 wt % and less than or equal to 10 wt %, greater than or equal to 0.1 wt % and less than or equal to 8 wt %, greater than or equal to 0.1 wt % and less than or equal to 6 wt %, greater than or equal to 0.1 wt % and less than or equal to 4 wt %, greater than or equal to 0.1 wt % and less than or equal to 2 wt %, greater than or equal to 0.25 wt % and less than or equal to 10 wt %, greater than or equal to 0.25 wt % and less than or equal to 8 wt %, greater than or equal to 0.25 wt % and less than or equal to 6 wt %, greater than or equal to 0.25 wt % and less than or equal to 4 wt %, greater than or equal to 0.25 wt % and less than or equal to 2 wt %, greater than or equal to 0.5 wt % and less than or equal to 10 wt %, greater than or equal to 0.5 wt % and less than or equal to 8 wt %, greater than or equal to 0.5 wt % and less than or equal to 6 wt %, greater than or equal to 0.5 wt % and less than or equal to 4 wt %, greater than or equal to 0.5 wt % and less than or equal to 2 wt %, greater than or equal to 0.75 wt % and less than or equal to 10 wt %, greater than or equal to 0.75 wt % and less than or equal to 8 wt %, greater than or equal to 0.75 wt % and less than or equal to 6 wt %, greater than or equal to 0.75 wt % and less than or equal to 4 wt %, or even greater than or equal to 0.75 wt % and less than or equal to 2 wt %, or any and all sub-ranges formed from any of these endpoints.

Hydrochloric Acid or Sulfuric Acid

Hydrochloric acid present in the etchant 100 may function to dissolve the components of the glass network of the aluminosilicate glass article 102 and form the polyhedral surface features 108. The amount of the hydrochloric acid in the etchant 100 should be sufficiently high (e.g., greater than or equal to 5 wt %) to ensure etching of glass and the formation of the textured glass article. The amount of hydrochloric acid may be limited (e.g., less than or equal to 30 wt %) to ensure polyhedral surface features are produced. When an excessive amount of hydrochloric acid is added, the polyhedral surface features may be corroded to a smaller size, losing their reflective appearance.

In embodiments, the etchant 100 may comprise greater than or equal to 5 wt % and less than or equal to 30 wt % hydrochloric acid. In embodiments, the etchant 100 may comprise greater than or equal to 7 wt % and less than or equal to 27 wt % hydrochloric acid. In embodiments, the etchant 100 may comprise greater than or equal to 10 wt % and less than or equal to 25 wt % hydrochloric acid. In embodiments, the amount of hydrochloric acid in the etchant 100 may be greater than or equal to 5 wt %, greater than or equal to 7 wt %, greater than or equal to 10 wt %, greater than or equal to 13 wt %, or even greater than or equal to 15 wt %. In embodiments, the amount of hydrochloric acid in the etchant 100 may be less than or equal to 30 wt %, less than or equal to 27 wt %, less than or equal to 25 wt %, less than or equal to 23 wt %, or even less than or equal to 20 wt %. In embodiments, the amount of hydrochloric acid in the etchant 100 may be greater than or equal to 5 wt % and less than or equal to 30 wt %, greater than or equal to 5 wt % and less than or equal to 27 wt %, greater than or equal to 5 wt % and less than or equal to 25 wt %, greater than or equal to 5 wt % and less than or equal to 23 wt %, greater than or equal to 5 wt % and less than or equal to 20 wt %, greater than or equal to 7 wt % and less than or equal to 30 wt %, greater than or equal to 7 wt % and less than or equal to 27 wt %, greater than or equal to 7 wt % and less than or equal to 25 wt %, greater than or equal to 7 wt % and less than or equal to 23 wt %, greater than or equal to 7 wt % and less than or equal to 20 wt %, greater than or equal to 10 wt % and less than or equal to 30 wt %, greater than or equal to 10 wt % and less than or equal to 27 wt %, greater than or equal to 10 wt % and less than or equal to 25 wt %, greater than or equal to 10 wt % and less than or equal to 23 wt %, greater than or equal to 10 wt % and less than or equal to 20 wt %, greater than or equal to 13 wt % and less than or equal to 30 wt %, greater than or equal to 13 wt % and less than or equal to 27 wt %, greater than or equal to 13 wt % and less than or equal to 25 wt %, greater than or equal to 13 wt % and less than or equal to 23 wt %, greater than or equal to 13 wt % and less than or equal to 20 wt %, greater than or equal to 15 wt % and less than or equal to 30 wt %, greater than or equal to 15 wt % and less than or equal to 27 wt %, greater than or equal to 15 wt % and less than or equal to 25 wt %, greater than or equal to 15 wt % and less than or equal to 23 wt %, or even greater than or equal to 15 wt % and less than or equal to 20 wt %, or any and all sub-ranges formed from any of these endpoints.

As an alternative to hydrochloric acid, in embodiments, sulfuric acid may be present in the etchant 100 to dissolve the components of the glass network of the aluminosilicate glass article 102 and form the polyhedral surface features 108. The amount of the sulfuric acid in the etchant 100 should be sufficiently high (e.g., greater than or equal to 15 wt %) to ensure etching of glass and the formation of the textured glass article. The amount of sulfuric acid may be limited (e.g., less than or equal to 45 wt %) to ensure polyhedral surface features are produced. When an excessive amount of sulfuric acid is added, the polyhedral surface features may be corroded to a smaller size, losing their reflective appearance.

In embodiments, the etchant 100 may comprise greater than or equal to 15 wt % and less than or equal to 45 wt % sulfuric acid. In embodiments, the etchant 100 may comprise greater than or equal to 17 wt % and less than or equal to 43 wt % sulfuric acid. In embodiments, the etchant 100 may comprise greater than or equal to 20 wt % and less than or equal to 40 wt % sulfuric acid. In embodiments, the etchant 100 may comprise greater than or equal to 25 wt % and less than or equal to 40 wt % sulfuric acid. In embodiments, the amount of sulfuric acid in the etchant 100 may be greater than or equal to 15 wt %, greater than or equal to 17 wt %, greater than or equal to 20 wt %, greater than or equal to 23 wt %, or even greater than or equal to 25 wt %. In embodiments, the amount of sulfuric acid in the etchant 100 may be less than or equal to 45 wt %, less than or equal to 43 wt %, less than or equal to 40 wt %, less than or equal to 37 wt %, or even less than or equal to 35 wt %. In embodiments, the amount of sulfuric acid in the etchant may be greater than or equal to 15 wt % and less than or equal to 45 wt %, greater than or equal to 15 wt % and less than or equal to 43 wt %, greater than or equal to 15 wt % and less than or equal to 40 wt %, greater than or equal to 15 wt % and less than or equal to 37 wt %, greater than or equal to 15 wt % and less than or equal to 35 wt %, greater than or equal to 17 wt % and less than or equal to 45 wt %, greater than or equal to 17 wt % and less than or equal to 43 wt %, greater than or equal to 17 wt % and less than or equal to 40 wt %, greater than or equal to 17 wt % and less than or equal to 37 wt %, greater than or equal to 17 wt % and less than or equal to 35 wt %, greater than or equal to 20 wt % and less than or equal to 45 wt %, greater than or equal to 20 wt % and less than or equal to 43 wt %, greater than or equal to 20 wt % and less than or equal to 40 wt %, greater than or equal to 20 wt % and less than or equal to 37 wt %, greater than or equal to 20 wt % and less than or equal to 35 wt %, greater than or equal to 23 wt % and less than or equal to 45 wt %, greater than or equal to 23 wt % and less than or equal to 43 wt %, greater than or equal to 23 wt % and less than or equal to 40 wt %, greater than or equal to 23 wt % and less than or equal to 37 wt %, greater than or equal to 23 wt % and less than or equal to 35 wt %, greater than or equal to 25 wt % and less than or equal to 45 wt %, greater than or equal to 25 wt % and less than or equal to 43 wt %, greater than or equal to 25 wt % and less than or equal to 40 wt %, greater than or equal to 25 wt % and less than or equal to 37 wt %, or even greater than or equal to 25 wt % and less than or equal to 35 wt %, or any and all sub-ranges formed from any of these endpoints.

Water

The water present in the etchant 100 acts as a solvent. In embodiments, the etchant 100 may comprise greater than or equal to 25 wt % and less than or equal to 60 wt % water. In embodiments, the etchant 100 may comprise greater than or equal to 30 wt % and less than or equal to 55 wt % water. In embodiments, the amount of water in the etchant 100 may be greater than or equal to 25 wt %, greater than or equal to 30 wt %, greater than or equal to 35 wt %, or even greater than or equal to 40 wt %. In embodiments, the amount of water in the etchant 100 may be less than or equal to 60 wt %, less than or equal to 55 wt %, or even less than or equal to 50 wt %. In embodiments, the amount of water in the etchant 100 may be greater than or equal to 25 wt % and less than or equal to 60 wt %, greater than or equal to 25 wt % and less than or equal to 55 wt %, greater than or equal to 25 wt % and less than or equal to 50 wt %, greater than or equal to 30 wt % and less than or equal to 60 wt %, greater than or equal to 30 wt % and less than or equal to 55 wt %, greater than or equal to 30 wt % and less than or equal to 50 wt %, greater than or equal to 35 wt % and less than or equal to 60 wt %, greater than or equal to 35 wt % and less than or equal to 55 wt %, greater than or equal to 35 wt % and less than or equal to 50 wt %, greater than or equal to 40 wt % and less than or equal to 60 wt %, greater than or equal to 40 wt % and less than or equal to 55 wt %, or even greater than or equal to 40 wt % and less than or equal to 50 wt % or any and all sub-ranges formed from any of these endpoints.

In embodiments, the etchant 100 disclosed herein may have a relatively high viscosity and be a slurry due to the presence and amounts of ammonium bifluoride and the silicon compound. The relatively high viscosity of the etchant 100 may help regulate the flow of the etchant, leading to sufficient coverage and micro-uniformity of the resulting polyhedral surface features. In embodiments, a weight ratio of a sum of the ammonium bifluoride and the silicon compound to a sum of the hydrochloric acid, the water, and the polyhydric alcohol may be from 0.3 to 0.9 or even from 0.3 to 0.6.

Sodium Salt or Potassium Salt

In embodiments, the etchant 100 disclosed herein may further comprise at least one of a sodium salt and a potassium salt to, along with ammonium bifluoride and/or ammonium fluoride, act as a crystallization promoter, encouraging the formation of crystal seeds. In embodiments, the at least one of a sodium salt and a potassium salt may comprise sodium chloride, sodium sulfate, sodium thiosulfate, sodium nitrate, sodium fluoride, sodium bifluoride, sodium carbonate, trisodium phosphate, disodium phosphate, monosodium phosphate, sodium gluconate, sodium citrate, sodium acetate, sodium dodecyl sulfate, sodium dodecyl benzene sulfonate, potassium chloride, potassium sulfate, potassium sulfite, potassium nitrate, potassium fluoride, potassium bifluoride, potassium carbonate, potassium phosphate, dipotassium phosphate, monopotassium phosphate, potassium gluconate, potassium citrate, potassium acetate, or a combination thereof. When present, the at least one of a sodium salt and a potassium salt should be present in the etchant in amounts to ensure the formation of crystal seeds (e.g., greater than or equal to 0.25 wt %). The amount of the at least one of a sodium salt and a potassium salt may be limited (e.g., less than or equal to 20 wt %) to reduce or prevent undissolved salt that may precipitate out once solubility is reached. Undissolved salt may etch differently than the etchant and may cause a lack of micro-uniformity. In embodiments, the etchant may comprise greater than or equal to 0.25 wt % and less than or equal to 20 wt % of the at least one of a sodium salt and a potassium salt. In embodiments, the amount of the at least one of a sodium salt and a potassium salt may be greater than or equal to 0.25 wt %, greater than or equal to 0.5 wt %, greater than or equal to 1 wt %, greater than or equal to 1.5 wt %, or even greater than or equal to 2 wt %. In embodiments, the amount of the at least one of a sodium salt and a potassium salt may be less than or equal to 20 wt %, less than or equal to 17 wt %, less than or equal to 15 wt %, less than or equal to 13 wt %, less than or equal to 10 wt %, or even less than or equal to 7 wt %. In embodiments, the amount of the at least one of a sodium salt and a potassium salt may be greater than or equal to 0.25 wt % and less than or equal to 20 wt %, greater than or equal to 0.25 wt % and less than or equal to 17 wt %, greater than or equal to 0.25 wt % and less than or equal to 15 wt %, greater than or equal to 0.25 wt % and less than or equal to 13 wt %, greater than or equal to 0.25 wt % and less than or equal to 10 wt %, greater than or equal to 0.25 wt % and less than or equal to 7 wt %, greater than or equal to 0.5 wt % and less than or equal to 20 wt %, greater than or equal to 0.5 wt % and less than or equal to 17 wt %, greater than or equal to 0.5 wt % and less than or equal to 15 wt %, greater than or equal to 0.5 wt % and less than or equal to 13 wt %, greater than or equal to 0.5 wt % and less than or equal to 10 wt %, greater than or equal to 0.5 wt % and less than or equal to 7 wt %, greater than or equal to 1 wt % and less than or equal to 20 wt %, greater than or equal to 1 wt % and less than or equal to 17 wt %, greater than or equal to 1 wt % and less than or equal to 15 wt %, greater than or equal to 1 wt % and less than or equal to 13 wt %, greater than or equal to 1 wt % and less than or equal to 10 wt %, greater than or equal to 1 wt % and less than or equal to 7 wt %, greater than or equal to 1.5 wt % and less than or equal to 20 wt %, greater than or equal to 1.5 wt % and less than or equal to 17 wt %, greater than or equal to 1.5 wt % and less than or equal to 15 wt %, greater than or equal to 1.5 wt % and less than or equal to 13 wt %, greater than or equal to 1.5 wt % and less than or equal to 10 wt %, greater than or equal to 1.5 wt % and less than or equal to 7 wt %, greater than or equal to 2 wt % and less than or equal to 20 wt %, greater than or equal to 2 wt % and less than or equal to 17 wt %, greater than or equal to 2 wt % and less than or equal to 15 wt %, greater than or equal to 2 wt % and less than or equal to 13 wt %, greater than or equal to 2 wt % and less than or equal to 10 wt %, or even greater than or equal to 2 wt % and less than or equal to 7 wt %, or any and all sub-ranges formed from any of these endpoints.

In embodiments, the etchant may comprise greater than or equal to 25 wt % and less than or equal to 40 wt % ammonium bifluoride; greater than or equal to 0.5 wt % and less than or equal to 4 wt % silica gel; greater than or equal to 13 wt % and less than or equal to 23 wt % hydrochloric acid; greater than or equal to 35 wt % and less than or equal to 25 wt % water; and greater than or equal to 1 wt % and less than or equal to 15 wt % glycerol.

In embodiments, the etchant may comprise greater than or equal to 10 wt % and less than or equal to 25 wt % ammonium fluoride; greater than or equal to 0.25 wt % and less than or equal to 2 wt % ammonium hexafluorosilicate; greater than or equal to 25 wt % and less than or equal to 40 wt % sulfuric acid; greater than or equal to 40 wt % and less than or equal to 60 wt % water; and greater than or equal to 0.1 wt % and less than or equal to 4 wt % of at least one of sodium gluconate and polydiallydimethylammonium chloride (PDADMAC).

Method of Forming Textured Glass Article

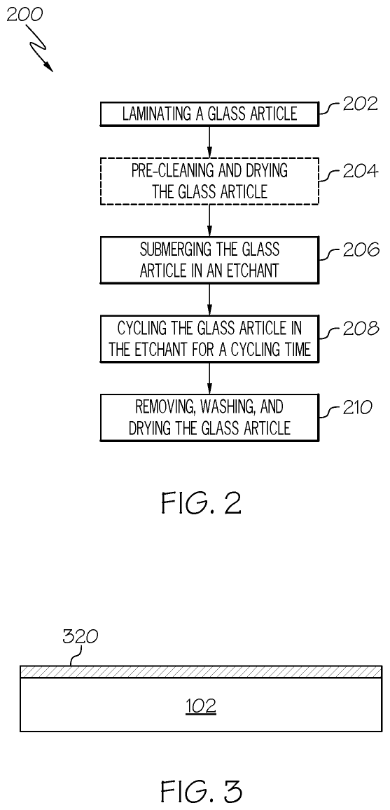

Referring now to FIGS. 2 and 3, the method 200 of forming a textured glass article begins at block 202 with laminating an aluminosilicate glass article 102 with a laminate 320. The aluminosilicate glass article 102 may be in the form of a plate. In embodiments, the laminate 320 may be a polyethylene film with an adhesive layer. In embodiments, laminating the aluminosilicate glass article 102 may be conducted in a roller lamination machine.

In embodiments, the aluminosilicate glass article 102 may comprise greater than or equal to 14 mol % Al₂O₃. In embodiments, the aluminosilicate glass article 102 may comprise greater than or equal to 50 mol % and less than or equal to 70 mol % SiO₂; greater than or equal to 10 mol % and less than or equal to 22 mol % Al₂O₃; greater than or equal to 0.5 mol % and less than or equal to 5 mol % P₂O₅; greater than or equal to 0 mol % and less than or equal to 10 mol % B₂O₅; greater than or equal to 0 mol % and less than or equal to 3 mol % MgO; greater than or equal to 0 mol % and less than or equal to 3 mol % ZnO; greater than or equal to 3 mol % and less than or equal to 12 mol % Li₂O; greater than or equal to 4 mol % and less than or equal to 15 mol % Na₂O; greater than or equal to 0 mol % and less than or equal to 2 mol % K₂O; and greater than or equal to 0 mol % and less than or equal to 1 mol % TiO₂.

Referring back to FIG. 2, in embodiments, the method 200 may optionally continue at block 204 with pre-cleaning (e.g., in an aqueous solution followed by rinsing (e.g., with DI water)) and drying (e.g., in an oven) the aluminosilicate glass article 102.

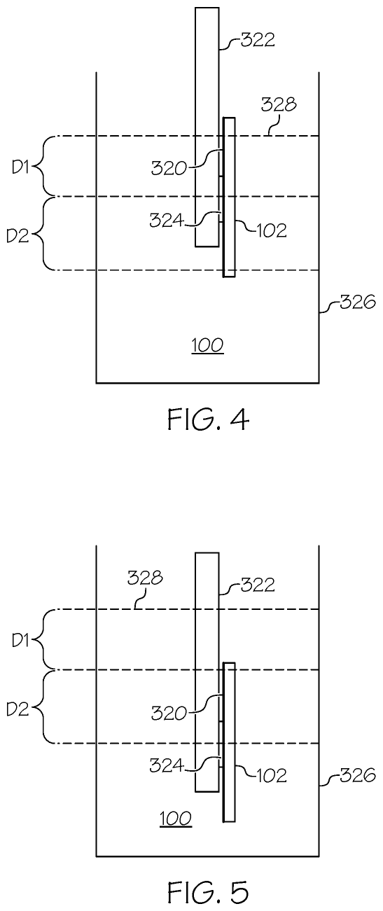

Referring back to FIG. 2 and now to FIG. 4, the method 200 continues at block 206 with submerging the aluminosilicate glass article 102 in an etchant 100. The etchant 100 may be the etchant as disclosed herein. In embodiments, the etchant 100 may be prepared by blending the components in powder form by hand mill and pre-mixing and stirring the components in liquid/solvent form to a homogenous state. The mixture of powder and liquid may be performed with pouring and stirring. The resulting etchant 100 may be aged for greater than or equal to 2 hours prior to submersion of the aluminosilicate glass article 102.

In embodiments, a temperature of the etchant 100 may be greater than or equal to 10° C. and less than or equal to 30° C. In embodiments, the temperature of the etchant 100 may be greater than or equal to 10° C., greater than or equal to 12° C., greater than or equal to 14° C., or even greater than or equal to 16° C. In embodiments, the temperature of the etchant 100 may be less than or equal to 30° C., less than or equal to 28° C., less than or equal to 26° C., or even less than or equal to 24° C. In embodiments, the temperature of the etchant 100 may be greater than or equal to 10° C. and less than or equal to 30° C., greater than or equal to 10° C. and less than or equal to 28° C., greater than or equal to 10° C. and less than or equal to 26° C., greater than or equal to 10° C. and less than or equal to 24° C., greater than or equal to 12° C. and less than or equal to 30° C., greater than or equal to 12° C. and less than or equal to 28° C., greater than or equal to 12° C. and less than or equal to 26° C., greater than or equal to 12° C. and less than or equal to 24° C., greater than or equal to 14° C. and less than or equal to 30° C., greater than or equal to 14° C. and less than or equal to 28° C., greater than or equal to 14° C. and less than or equal to 26° C., greater than or equal to 14° C. and less than or equal to 24° C., greater than or equal to 16° C. and less than or equal to 30° C., greater than or equal to 16° C. and less than or equal to 28° C., greater than or equal to 16° C. and less than or equal to 26° C., or even greater than or equal to 16° C. and less than or equal to 24° C., or any and all sub-ranges formed from any of these endpoints.

In embodiments, as shown in FIG. 4, the aluminosilicate glass article 102 may be secured to an arm 322 to facilitate submerging the aluminosilicate glass article 102 in the etchant 100. For example, in embodiments, an adhesive or suction cup 324 may be disposed between the laminate 320 and the arm 322 to secure the aluminosilicate glass article 102 to the arm 322. The arm 322 may be lowered into a tank 326 containing etchant 100, thereby submerging the aluminosilicate glass article 102 in the etchant 100.

Referring back to FIGS. 2 and 4 and now to FIG. 5, the method continues at block 208 with cycling the aluminosilicate glass article 102 in the etchant 100 between the upper submerging depth D1 (as shown in FIG. 4) and a lower submerging depth D2 (as shown in FIG. 5) for a cycling time. In embodiments, the aluminosilicate glass article 102 is cycled by moving arm 322 in a repetitive upward and downward motion. The lower submerging depth D2 is deeper than the upper submerging depth D1 relative to the surface 328 of the etchant 100.

In embodiments, the cycling may be conducted at a speed greater than or equal to 5 cm/s and less than or equal to 30 cm/s. In embodiments, the cycling speed may be greater than or equal to 5 cm/s or even greater than or equal to 10 cm/s. In embodiments, the cycling speed may be less than or equal to 30 cm/s, less than or equal to 25 cm/s, or even less than or equal to 20 cm/s. In embodiments, the cycling may be conducted at a speed greater than or equal to 5 cm/s and less than or equal to 30 cm/s, greater than or equal to 5 cm/s and less than or equal to 25 cm/s, greater than or equal to 5 cm/s and less than or equal to 20 cm/s, greater than or equal to 10 cm/s and less than or equal to 30 cm/s, greater than or equal to 10 cm/s and less than or equal to 25 cm/s, or even greater than or equal to 10 cm/s and less than or equal to 20 cm/s, or any and all sub-ranges formed from any of these endpoints.

In embodiments, the cycling may be conducted at a speed greater than or equal to 3 cm/s and less than or equal to 30 cm/s. In embodiments, the cycling speed may be greater than or equal to 3 cm/s, greater than or equal to 5 cm/s, or even greater than or equal to 10 cm/s. In embodiments, the cycling speed may be less than or equal to 30 cm/s, less than or equal to 25 cm/s, or even less than or equal to 20 cm/s. In embodiments, the cycling may be conducted at a speed greater than or equal to 3 cm/s and less than or equal to 30 cm/s, greater than or equal to 3 cm/s and less than or equal to 25 cm/s, greater than or equal to 3 cm/s and less than or equal to 20 cm/s, greater than or equal to 5 cm/s and less than or equal to 30 cm/s, greater than or equal to 5 cm/s and less than or equal to 25 cm/s, greater than or equal to 5 cm/s and less than or equal to 20 cm/s, greater than or equal to 10 cm/s and less than or equal to 30 cm/s, greater than or equal to 10 cm/s and less than or equal to 25 cm/s, or even greater than or equal to 10 cm/s and less than or equal to 20 cm/s, or any and all sub-ranges formed from any of these endpoints.

Cycling helps achieve sufficient coverage and micro-uniformity of the polyhedral surface features. In embodiments, the cycling time may be greater than or equal to 60 s and less than or equal to 600 s. In embodiments, the cycling time may be greater than or equal to 60 s, greater than or equal to 120 s, greater than or equal to 180 s, or even greater than or equal to 240 s. In embodiments, the cycling time may be less than or equal to 600 s, less than or equal to 480 s, or even less than or equal to 360 s. In embodiments, the cycling time may be greater than or equal to 60 s and less than or equal to 600 s, greater than or equal to 60 s and less than or equal to 480 s, greater than or equal to 60 s and less than or equal to 360 s, greater than or equal to 120 s and less than or equal to 600 s, greater than or equal to 120 s and less than or equal to 480 s, greater than or equal to 120 s and less than or equal to 360 s, greater than or equal to 180 s and less than or equal to 600 s, greater than or equal to 180 s and less than or equal to 480 s, or even greater than or equal to 180 s and less than or equal to 360 s, or any and all sub-ranges formed from any of these endpoints.

In embodiments, the cycling time may be greater than or equal to 30 s and less than or equal to 600 s. In embodiments, the cycling time may be greater than or equal to 30 s, greater than or equal to 60 s, greater than or equal to 120 s, greater than or equal to 180 s, or even greater than or equal to 240 s. In embodiments, the cycling time may be less than or equal to 600 s, less than or equal to 480 s, or even less than or equal to 360 s. In embodiments, the cycling time may be greater than or equal to 30 s and less than or equal to 600 s, greater than or equal to 30 s and less than or equal to 480 s, greater than or equal to 30 s and less than or equal to 360 s, greater than or equal to 60 s and less than or equal to 600 s, greater than or equal to 60 s and less than or equal to 480 s, greater than or equal to 60 s and less than or equal to 360 s, greater than or equal to 120 s and less than or equal to 600 s, greater than or equal to 120 s and less than or equal to 480 s, greater than or equal to 120 s and less than or equal to 360 s, greater than or equal to 180 s and less than or equal to 600 s, greater than or equal to 180 s and less than or equal to 480 s, or even greater than or equal to 180 s and less than or equal to 360 s, or any and all sub-ranges formed from any of these endpoints.

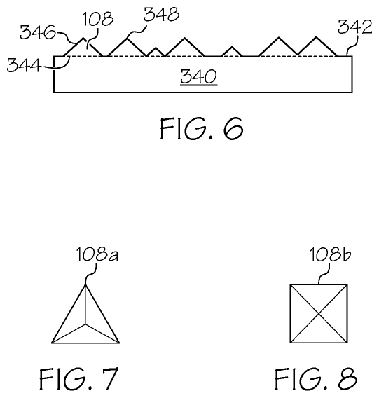

Referring back to FIG. 2 and to FIG. 6, the method 200 continues at block 210 with removing the aluminosilicate glass article 102 from the etchant 100, washing the aluminosilicate glass article 102 to remove the etchant 100 and crystal seeds 106 from the surface, and drying the article to form the textured glass article 340 having polyhedral surface features 108. The aluminosilicate glass article 102 may be removed from arm 322. In embodiments, the etchant may be rinsed off the aluminosilicate glass article 102 with deionized (DI) water. In embodiments, crystal seeds 106 adhering to the aluminosilicate glass article 102 may be removed or scratched off by, for example, a scrubber sponge. In embodiments, the laminate 320 may be removed. In embodiments, the aluminosilicate glass article 102 may be dried in ambient condition or in an oven.

As shown in FIG. 6, the resulting textured glass article 340 comprises a plurality of polyhedral surface features 108 extending from a first surface 342. Each of the plurality of polyhedral surface features 108 comprises a base 344 on the first surface 342, a plurality of facets 346 extending from the first surface 342, and at least one apex 348.

In embodiments, the facets 346 of each polyhedral surface feature 108 extend from the first surface 342 and converge toward one another to form the polyhedral morphology (e.g., pyramidal with 3-fold symmetry or 4-fold symmetry) of the polyhedral surface features 108. For example, as shown in FIGS. 7 and 8, in embodiments, the polyhedral surface features 108 may comprise triangular pyramids 108a, quadrangular pyramids 108b, or a combination thereof.

In embodiments, a surface feature size at the base 344 may be greater than or equal to 50 μm and less than or equal to 300 μm. In embodiments, the surface feature size at the base 344 may be greater than or equal to 50 μm, greater than or equal to 75 μm, or even greater than or equal to 100 μm. In embodiments, the surface feature size at the base 344 may be less than or equal to 300 μm, less than or equal to 250 μm, less than or equal to 200 μm, or even less than or equal to 150 μm. In embodiments, the surface feature size at the base 344 may be greater than or equal to 50 μm and less than or equal to 300 μm, greater than or equal to 50 μm and less than or equal to 250 μm, greater than or equal to 50 μm and less than or equal to 200 μm, greater than or equal to 50 μm and less than or equal to 150 μm, greater than or equal to 75 μm and less than or equal to 300 μm, greater than or equal to 75 μm and less than or equal to 250 μm, greater than or equal to 75 μm and less than or equal to 200 μm, greater than or equal to 75 μm and less than or equal to 150 μm, greater than or equal to 100 μm and less than or equal to 300 μm, greater than or equal to 100 μm and less than or equal to 250 μm, greater than or equal to 100 μm and less than or equal to 200 μm, or even greater than or equal to 100 μm and less than or equal to 150 μm, or any and all sub-ranges formed from any of these endpoints.

In embodiments, a surface feature height may be greater than or equal to 10 μm and less than or equal to 40 μm. In embodiments, a surface feature height may be greater than or equal to 8 μm and less than or equal to 40 μm. In embodiments, a surface feature height may be greater than or equal to 8 μm, greater than or equal to 10 μm, greater than or equal to 12 μm, or even greater than or equal to 15 μm. In embodiments, a surface feature height may be less than or equal to 40 μm, less than or equal to 35 μm, less than or equal to 30 μm, less than or equal to 25 μm, or even less than or equal to 20 μm. In embodiments, a surface feature height may be greater than or equal to 8 μm and less than or equal to 40 μm, greater than or equal to 8 μm and less than or equal to 35 μm, greater than or equal to 8 μm and less than or equal to 30 μm, greater than or equal to 8 μm and less than or equal to 25 μm, greater than or equal to 8 μm and less than or equal to 20 μm, greater than or equal to 10 μm and less than or equal to 40 μm, greater than or equal to 10 μm and less than or equal to 35 μm, greater than or equal to 10 μm and less than or equal to 30 μm, greater than or equal to 10 μm and less than or equal to 25 μm, greater than or equal to 10 μm and less than or equal to 20 μm, greater than or equal to 12 μm and less than or equal to 40 μm, greater than or equal to 12 μm and less than or equal to 35 μm, greater than or equal to 12 μm and less than or equal to 30 μm, greater than or equal to 12 μm and less than or equal to 25 μm, greater than or equal to 12 μm and less than or equal to 20 μm, greater than or equal to 15 μm and less than or equal to 40 μm, greater than or equal to 15 μm and less than or equal to 35 μm, greater than or equal to 15 μm and less than or equal to 30 μm, greater than or equal to 15 μm and less than or equal to 25 μm, or even greater than or equal to 15 μm and less than or equal to 20 μm, or any and all sub-ranges formed from any of these endpoints.

In embodiments, the polyhedral surface features 108 may comprise a facet angle greater than or equal to 13° and less than or equal to 20°. In embodiments, the polyhedral surface features 108 may comprise a facet angle greater than or equal to 13° or even greater than or equal to 15°. In embodiments, the polyhedral surface features 108 may comprise a facet angle less than or equal to 20° or even less than or equal to 18°. In embodiments, the polyhedral surface features 108 may comprise a facet angle greater than or equal to 13° and less than or equal to 20°, greater than or equal to 13° and less than or equal to 18°, greater than or equal to 15° and less than or equal to 20°, or even greater than or equal to 15° and less than or equal to 18°, or any and all sub-ranges formed from any of these endpoint.

In embodiments, the polyhedral surface features 108 may comprise a surface roughness greater than or equal to 2 μm and less than or equal to 7 μm. In embodiments, the polyhedral surface features 108 may comprise a surface roughness greater than or equal to 2 μm or even greater than or equal to 4 μm. In embodiments, the polyhedral surface features 108 may comprise a surface roughness less than or equal to 7 μm or even less than or equal to 6 μm. In embodiments, the polyhedral surface features 108 may comprise a surface roughness greater than or equal to 2 μm and less than or equal to 7 μm, greater than or equal to 2 μm and less than or equal to 6 μm, greater than or equal to 4 μm and less than or equal to 7 μm, or even greater than or equal to 4 μm and less than or equal to 6 μm, or any and all sub-ranges formed from any of these endpoints.

In embodiments, the polyhedral surface features 108 may comprise a surface roughness greater than or equal to 1 μm and less than or equal to 7 μm. In embodiments, the polyhedral surface features 108 may comprise a surface roughness greater than or equal to 1 μm or even greater than or equal to 3 μm. In embodiments, the polyhedral surface features 108 may comprise a surface roughness less than or equal to 7 μm or even less than or equal to 6 μm. In embodiments, the polyhedral surface features 108 may comprise a surface roughness greater than or equal to 1 μm and less than or equal to 7 μm, greater than or equal to 1 μm and less than or equal to 6 μm, greater than or equal to 3 μm and less than or equal to 7 μm, or even greater than or equal to 3 μm and less than or equal to 6 μm, or any and all sub-ranges formed from any of these endpoints.

In embodiments, the polyhedral surface features 108 may comprise a transmittance greater than or equal to 80% and less than or equal to 95%. In embodiments, the polyhedral surface features 108 comprise a transmittance greater than or equal to 80% or even greater than or equal to 85%. In embodiments, the polyhedral surface features 108 comprise a transmittance less than or equal to 95% or even less than or equal to 90%. In embodiments, the polyhedral surface features 108 may comprise a transmittance greater than or equal to 80% and less than or equal to 95%, greater than or equal to 80% and less than or equal to 90%, greater than or equal to 85% and less than or equal to 95%, or even greater than or equal to 85% and less than or equal to 90%, or any and all sub-ranges formed from any of these endpoints.

In embodiments, the polyhedral surface features 108 may comprise a transmittance haze greater than or equal to 95% and less than or equal to 100%. In embodiments, the polyhedral surface features 108 may comprise a transmittance haze greater than or equal to 95%, greater than or equal to 97%, or even greater than or equal to 99%. In embodiments, the polyhedral surface features 108 may comprise a transmittance haze less than or equal to 100%. In embodiments, the polyhedral surface features 108 comprise a transmittance haze greater than or equal to 95% and less than or equal to 100%, greater than or equal to 97% and less than or equal to 100%, or even greater than or equal to 99% and less than or equal to 100%, or any and all sub-ranges formed from any of these endpoints.

In embodiments, the polyhedral surface features 108 may comprise a transmittance haze greater than or equal to 80% and less than or equal to 100%. In embodiments, the polyhedral surface features 108 may comprise a transmittance haze greater than or equal to 80%, greater than or equal to 85%, or even greater than or equal to 90%. In embodiments, the polyhedral surface features 108 may comprise a transmittance haze less than or equal to 100%. In embodiments, the polyhedral surface features 108 comprise a transmittance haze greater than or equal to 80% and less than or equal to 100%, greater than or equal to 85% and less than or equal to 100%, or even greater than or equal to 90% and less than or equal to 100%, or any and all sub-ranges formed from any of these endpoints.

The structure and size of each polyhedral surface feature 108, along with sufficient coverage a micro-uniformity thereof, helps to achieve enhanced glowing.

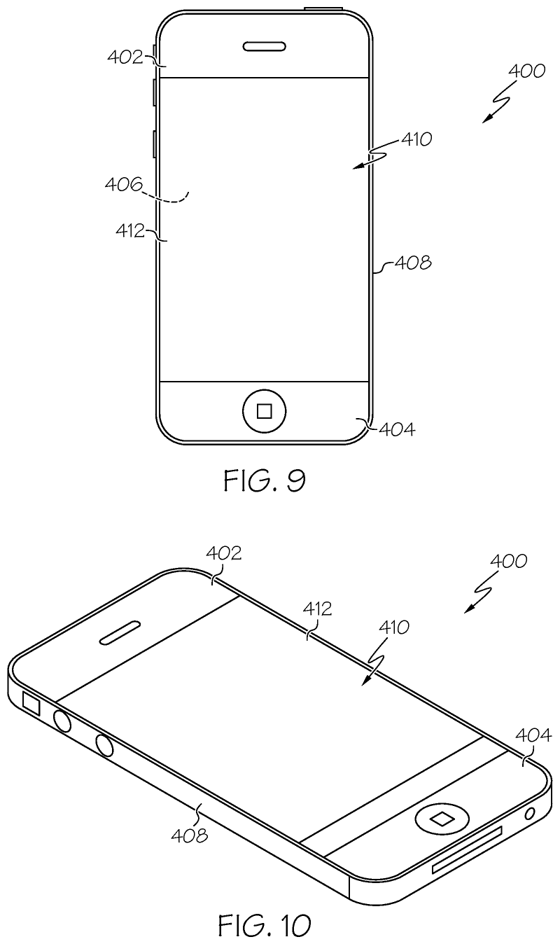

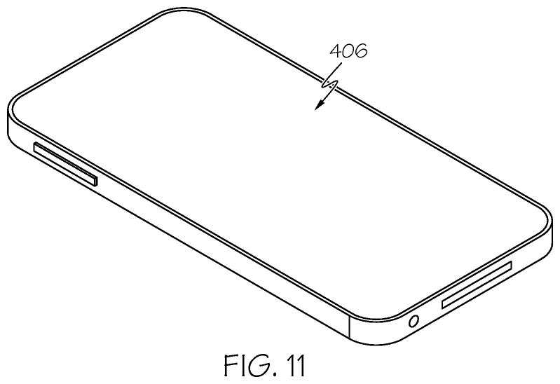

The textured glass articles described herein may be used for a variety of applications including, for example, back cover applications in consumer or commercial electronic devices such as smartphones, tablet computers, personal computers, ultrabooks, televisions, and cameras. An exemplary article incorporating any of the textured glass articles disclosed herein is shown in FIGS. 9-11. Specifically, FIGS. 9-11 show a consumer electronic device 400 including a housing 402 having front 404, back 406, and side surfaces 408; electrical components (not shown) that are at least partially inside or entirely within the housing and including at least a controller, a memory, and a display 410 at or adjacent to the front surface of the housing; and a cover substrate 412 at or over the front surface of the housing such that it is over the display. In embodiments, a portion of housing 402, such as the back 406, may include any of the textured glass articles disclosed herein.

### EXAMPLES

In order that various embodiments be more readily understood, reference is made to the following examples, which illustrate various embodiments of the etchants described herein.

The compositions of Glass Articles A, B, C, and D (in mol %) treated as described below are shown in Table 1. Note that reference to “Glass Article A,” “Glass Article B,” “Glass Article C,” and “Glass Article D” refers to a glass article that has the respective composition shown in Table 1. References to Glass Articles A-D do not refer to the same Glass Articles A-D, respectively, that were treated multiple times with the various etchants.

TABLE 1

| Glass Article | A | B | C | D |
|---|---|---|---|---|
| SiO₂ | 58.65 | 64.40 | 63.57 | 63.65 |
| Al₂O₃ | 17.85 | 15.90 | 15.06 | 16.19 |
| P₂O₅ | 1.47 | 1.25 | 2.50 | 2.67 |
| B₂O₃ | 4.22 | — | 2.40 | 0.38 |
| MgO | 1.19 | — | — | 0.33 |
| ZnO | — | 1.20 | 1.18 | — |
| Li₂O | 7.70 | 6.30 | 5.96 | 8.07 |
| Na₂O | 8.72 | 11.00 | 9.26 | 8.11 |
| K₂O | 0.07 | — | — | 0.52 |
| TiO₂ | 0.10 | — | — | — |

Table 2 shows the composition of Example Etchants A-I and Comparative Etchant X (in wt %).

TABLE 2

| | Example | Example | Example | Example | Example |
|---|---|---|---|---|---|
| Etchant | Etchant A | Etchant B | Etchant C | Etchant D | Etchant E |
| NH₄HF₂ | 32.86 | 29.75 | 32.94 | 27.47 | 27.32 |
| NH₄F | — | — | — | — | — |
| (NH)₂SiF₆ | — | — | — | — | — |
| NaF | — | — | — | 11.07 | — |
| KHF₂ | — | — | — | — | 2.70 |
| SiO₂ gel | 0.84 | 0.61 | 2.67 | 0.99 | 0.84 |
| NaC₆H₁₁O₇ | — | — | — | — | — |
| PDADMAC | — | — | — | — | — |
| HCl | 17.24 | 18.80 | 16.16 | 13.75 | 15.04 |
| H₂SO₄ | — | — | — | — | — |
| H₂O | 47.07 | 41.37 | 45.98 | 41.19 | 35.05 |
| C₃H₈O₃ | 1.99 | 9.47 | 2.25 | 5.53 | 19.06 |
| | Example | Example | Example | Example | Comparative |
| Etchant | Etchant F | Etchant G | Etchant H | Etchant I | Etchant X |
| NH₄HF₂ | 20.47 | — | — | — | — |
| NH₄F | 6.24 | 17.64 | 17.94 | 17.59 | 17.99 |
| (NH)₂SiF₆ | — | 0.59 | 0.6 | 0.59 | 0.60 |
| NaF | 5.94 | — | — | — | — |
| KHF₂ | — | — | — | — | — |
| SiO₂ gel | 1.02 | — | — | — | — |
| NaC₆H₁₁O₇ | — | 1.97 | — | 1.96 | — |
| PDADMAC | — | — | 0.3 | 0.29 | — |
| HCl | 15.15 | — | — | — | — |
| H₂SO₄ | — | 31.71 | 32.25 | 31.62 | 32.34 |
| H₂O | 45.24 | 48.09 | 48.91 | 47.95 | 49.06 |
| C₃H₈O₃ | 5.94 | — | — | — | — |

Table 3 shows the properties of Example Articles A-G formed as described in Examples 1-7 below.

TABLE 3

| | Example | Example | Example | Example |
|---|---|---|---|---|
| | Article A | Article B | Article C | Article D |
| Surface feature size (μm) | 140 | 115 | 89 | 105 |
| Surface feature height (μm) | 30 | 13 | — | — |
| Triangular pyramid | 18.5 | 15.0 | — | — |
| facet angle (°) | | | | |
| Quadrangular pyramid | 19.0 | 15.0 | — | — |
| facet angle (°) | | | | |
| Surface roughness (μm) | 6.0 | 4.0 | 4.6 | 4.5 |
| Transmittance (%) | 91.5 | 90.2 | 89.5 | 90.0 |
| Transmittance haze (%) | 100.0 | 99.5 | 99.5 | 99.7 |

| | Example | Example | Example |
|---|---|---|---|
| | Article E | Article F | Article G |
| Surface feature size (μm) | 90 | 65 | 96 |
| Surface feature height (μm) | 15 | 9 | 17 |
| Triangular pyramid | — | — | — |
| facet angle (°) | | | |
| Quadrangular pyramid | — | — | — |
| facet angle (°) | | | |
| Surface roughness (μm) | 2.7 | 1.4 | 3.3 |
| Transmittance (%) | 91.5 | 90.6 | 91.0 |
| Transmittance haze (%) | 86.6 | 93.5 | 98.5 |

### Example 1—Example Textured Article a (Example Etchant a and Glass Article A)

To obtain Example Etchant A, 616 g blended powder including 97.5 wt % NH₄HF₂ and 2.5 wt % SiO₂ gel was obtained by hand mill. 1212 g pre-mixed solvent including 26.0 wt % HCl, 71.0 wt % H₂O, and 3.0 wt % C₃H₈O₃ was obtained and stirred adequately. The mixture of powder and solvent was performed at 24° C. The etchant was cooled to 12° C.

Glass Article A was cut to 50×50 mm size and laminated on one side. The laminated Glass Article A underwent a 10 min ultrasonic treatment in 3% Parker aqueous solution, followed by adequate rinsing with running DI water. Thereafter, Glass Article A was dried at 60° C. in an oven, followed by placement in ambient condition until Glass Article A cooled to 24° C.

Glass Article A was submerged and cycled in Example Etchant A for a period of 240 s and at a cycling speed of 20 cm/s. The temperature of Example Etchant A was 12° C.

Etched Glass Article A was flushed with running DI water. The precipitates on the etched glass article were removed by scratching and the laminate was peeled off. The glass article was placed in a 60° C. oven until dry.

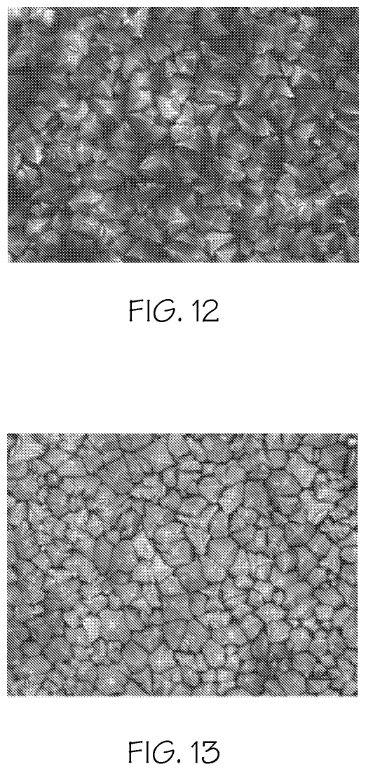

Referring now to FIG. 12, treating Glass Article A with Example Etchant A resulted in Example Textured Article A having sufficient coverage and micro-uniformity of the resulting polyhedral surface features. As shown in FIG. 12, Example Textured Article A included triangular and quadrangular pyramids.

As shown in Table 3 above, Example Textured Article A had a surface feature size of 140 μm, a surface feature height of 30 μm, a triangular pyramid facet angle of 18.5°, a quadrangular pyramid facet angle of 19.0°, a surface roughness of 6.0 μm, a transmittance of 91.5%, and a transmittance haze of 100.0%.

### Example 2—Example Textured Article B (Example Etchant B and Glass Article B)

To obtain Example Etchant B, 153 g blended powder including 98.0 wt % NH₄HF₂ and 2.5 wt % SiO₂ gel was obtained by hand mill. 351 g pre-mixed solvent including 27.0 wt % HCl, 59.4 wt % H₂O, and 13.6 wt % C₃H₈O₃ was obtained and stirred adequately. The mixture of powder and solvent was performed at 24° C. The etchant was cooled to 16° C.

Glass Article B was subjected to the same treatment as Glass Article A in Example 1 prior to etching.

Glass Article B was submerged and cycled in Example Etchant B for a period of 120 s and at a cycling speed of 10 cm/s. The temperature of Example Etchant B was 16° C.

Etched Glass Article B was subjected to the same treatment as Glass Article A in Example 1 after etching.

Referring now to FIG. 13, treating Glass Article B with Example Etchant B resulted in Example Textured Article B having sufficient coverage and micro-uniformity of the resulting polyhedral surface features. As shown in FIG. 13, Example Textured Article B included triangular and quadrangular pyramids.

As shown in Table 3 above, Example Textured Article B had a surface feature size of 115 μm, a surface feature height of 13 μm, a triangular pyramid facet angle of 15.0°, a quadrangular pyramid facet angle of 15.0°, a surface roughness of 4.0 μm, a transmittance of 90.2%, and a transmittance haze of 99.5%.

### Example 3—Example Textured Article C (Example Etchant C and Glass Article C)

To obtain Example Etchant C, 616 g blended powder including 92.5 wt % NH₄HF₂ and 7.5 wt % SiO₂ gel was obtained by hand mill. 1114 g pre-mixed solvent including 25.1 wt % HCl, 71.4 wt % H₂O, and 3.5 wt % C₃H₈O₃ was obtained and stirred adequately. The mixture of powder and solvent was performed at 24° C. The etchant was cooled to 14° C.

Glass Article C was subjected to the same treatment as Glass Article A in Example 1 prior to etching.

Glass Article C was submerged and cycled in Example Etchant C for a period of 300 s and at a cycling speed of 15 cm/s. The temperature of Etchant C was 14° C.

Etched Glass Article C was subjected to the same treatment as Glass Article A in Example 1 after etching.

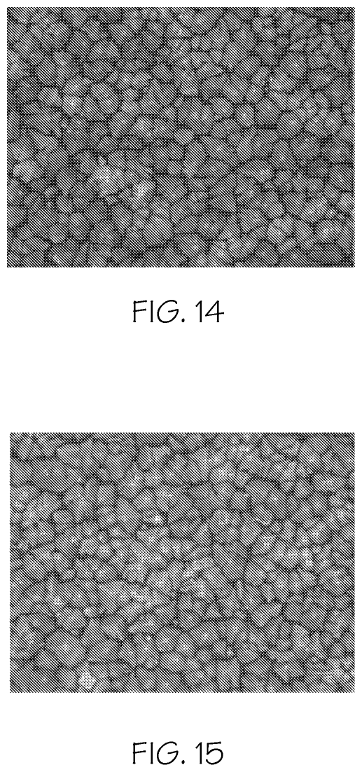

Referring now to FIG. 14, treating Glass Article C with Example Etchant C resulted in Example Textured Article C having sufficient coverage and micro-uniformity of the resulting polyhedral surface features. As shown in FIG. 14, Example Textured Article C included triangular and quadrangular pyramids.

As shown in Table 3 above, Example Textured Article C had a surface feature size of 89 μm, a surface roughness of 4.6 μm, a transmittance of 89.5%, and a transmittance haze of 99.5%.

### Example 4—Example Textured Article D (Example Etchant C and Glass Article D)

Example Etchant C was prepared as described in Example 3.

Glass Article D was subjected to the same treatment as Glass Article A in Example 1 prior to etching.

Glass Article D was submerged and cycled in Example Etchant C for a period of 300 s and at a cycling speed of 15 cm/s. The temperature of Etchant C was 14° C.

Etched Glass Article D was subjected to the same treatment as Glass Article A in Example 1 after etching.

Referring now to FIG. 15, treating Glass Article D with Example Etchant C resulted in Example Textured Article D having sufficient coverage and micro-uniformity of the resulting polyhedral surface features. As shown in FIG. 15, Example Textured Article D included triangular and quadrangular pyramids.

As shown in Table 3 above, Example Textured Article D had a surface feature size of 105 μm, a surface roughness of 4.5 μm, a transmittance of 90%, and a transmittance haze of 99.7%.

### Example 5—Example Textured Article E (Example Etchant D and Glass Article B)

To obtain Example Etchant D, 195 g blended powder including 69.5 wt % NH₄HF₂, 28 wt % NaF, and 2.5 wt % SiO₂ gel was obtained by hand mill. 306 g pre-mixed solvent including 22.7 wt % HCl, 68.1 wt % H₂O, and 9.2 wt % C₃H₈O₃ was obtained and stirred adequately. The mixture of powder and solvent was performed at 24° C. The etchant was maintained at 24° C.

Glass Article B was subjected to the same treatment as Glass Article A in Example 1 prior to etching.

Glass Article B was submerged and cycled in Example Etchant D for a period of 120 s and at a cycling speed of 10 cm/s. The temperature of Etchant D was 24° C.

Glass Article B was subjected to the same treatment as Glass Article A in Example 1 after etching.

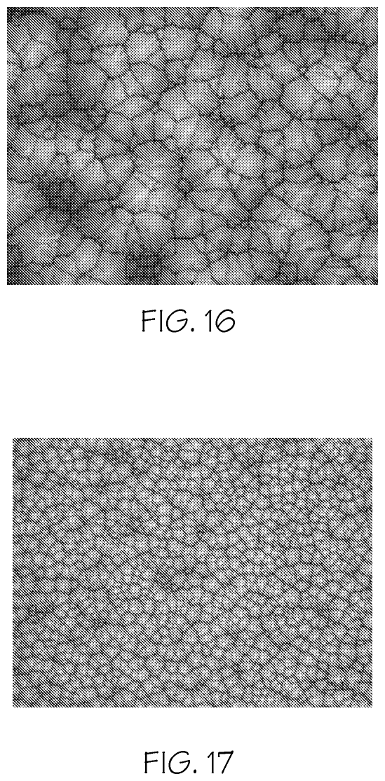

Referring now to FIG. 16, treating Glass Article B with Example Etchant D resulted in Example Textured Article E having sufficient coverage and micro-uniformity of the resulting polyhedral surface features. As shown in FIG. 16, Example Textured Article E included triangular and quadrangular pyramids.

As shown in Table 3 above, Example Textured Article E had a surface feature size of 90 μm, a surface feature height of 15 μm, a surface roughness of 2.7 μm, a transmittance of 91.5%, and a transmittance haze of 86.6%.

### Example 6—Example Textured Article F (Example Etchant E and Glass Article B)

To obtain Example Etchant E, 183 g blended powder including 88.5 wt % NH₄HF₂, 8.7 wt % KHF₂, and 2.7 wt % SiO₂ gel was obtained by hand mill. 410 g pre-mixed solvent including 21.7 wt % HCl, 50.7 wt % H₂O, and 27.6 wt % C₃H₈O₃ was obtained and stirred adequately. The mixture of powder and solvent was performed at 24° C. The etchant was heated to 28° C.

Glass Article B was subjected to the same treatment as Glass Article A in Example 1 prior to etching.

Glass Article B was submerged and cycled in Example Etchant E for a period of 120 s and at a cycling speed of 20 cm/s. The temperature of Etchant E was 28° C.

Glass Article B was subjected to the same treatment as Glass Article A in Example 1 after etching.

Referring now to FIG. 17, treating Glass Article B with Example Etchant E resulted in Example Textured Article F having sufficient coverage and micro-uniformity of the resulting polyhedral surface features. As shown in FIG. 17, Example Textured Article F included triangular and quadrangular pyramids.

As shown in Table 3 above, Example Textured Article F had a surface feature size of 65 μm, a surface feature height of 9 μm, a surface roughness of 1.4 μm, a transmittance of 90.6%, and a transmittance haze of 93.5%.

### Example 7—Example Textured Article G (Example Etchant F and Glass Article A)

To obtain Example Etchant F, 164.5 g blended powder including 60.8 wt % NH₄HF₂, 18.5 wt % NH₄F, 17.6 wt % NaF, and 1.2 wt % SiO₂ gel was obtained by hand mill. 323 g pre-mixed solvent including 22.8 wt % HCl, 68.2 wt % H₂O, and 9.0 wt % C₃H₈O₃ was obtained and stirred adequately. The mixture of powder and solvent was performed at 24° C. The etchant was cooled to 16° C.

Glass Article A was subjected to the same treatment as Glass Article A in Example 1 prior to etching.

Glass Article A was submerged and cycled in Example Etchant F for a period of 200 s and at a cycling speed of 10 cm/s. The temperature of Etchant F was 16° C.

Glass Article B was subjected to the same treatment as Glass Article A in Example 1 after etching.

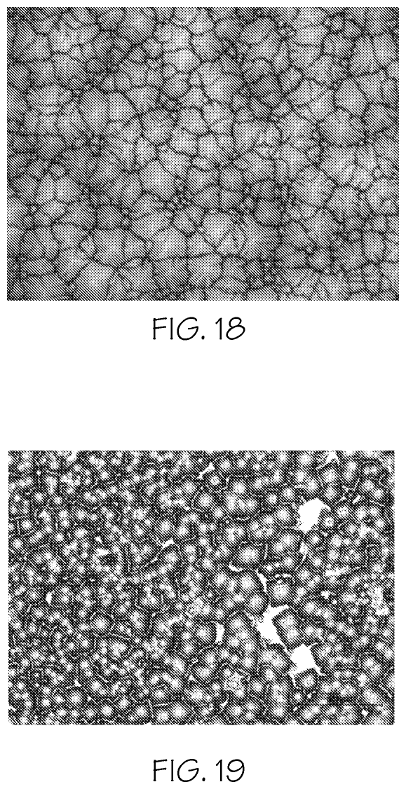

Referring now to FIG. 18, treating Glass Article A with Example Etchant F resulted in Example Textured Article G having sufficient coverage and micro-uniformity of the resulting polyhedral surface features. As shown in FIG. 18, Example Textured Article G included triangular and quadrangular pyramids.

As shown in Table 3 above, Example Textured Article G had a surface feature size of 96 μm, a surface feature height of 17 μm, a surface roughness of 3.3 μm, a transmittance of 91.0%, and a transmittance haze of 98.5%.

### Comparative Example 1—Comparative Textured Article X (Comparative Etchant X and Glass Article A)

To obtain Comparative Etchant X, blended powder including 89.7 g NH₄F and 3 g (NH)₂SiF₆ was obtained by hand mill. Pre-mixed solvent including 167.08 g (96.5 wt %) H₂SO₄ and 238.7 g H₂O was obtained and stirred adequately. The mixture of powder and solvent was performed at 24° C. The etching solution was aged for 2 hrs.

Glass Article A was cut to 50×50 mm size and underwent 4 min ultrasonic treatment in 3-4% Parker aqueous solution, followed by a final soak in ultra-pure water for an additional 6 minutes. Thereafter, Glass Article A was dried at 120 C in an oven, followed by placement in ambient condition until Glass Article A cooled to 24° C.

Prior to etching, Comparative Etchant X had been settled down for 300 s. Glass Article A was submerged and cycled in Comparative Etchant X for a period of 30 s and at a cycling speed of 4 cm/s. Glass Article A was then held stable (i.e., no cycling) in Comparative Etchant X for 30 s. The temperature of Comparative Etchant X was 12° C.

Etched Glass Article A was flushed with running DI water. The precipitates on the etched glass article were removed by scratching and the laminate was peeled off. The glass article was placed in a 60° C. oven until dry.

Referring now to FIG. 19, treating Glass Article A with Comparative Etchant X resulted in Comparative Textured Article X lacking sufficient coverage and micro-uniformity of the resulting polyhedral surface features. Comparative Textured Article X included triangular and quadrangular pyramids and had a surface feature size of 75 μm.

### Example 8—Example Textured Article H (Example Etchant G and Glass Article A)

To obtain Example Etchant G, blended powder including 89.7 g NH₄F, 3 g (NH)₂SiF₆, and 10 g NaC₆H₁₁O₇ was obtained by hand mill. Pre-mixed solvent including 167.08 g (96.5 wt %) H₂SO₄ and 238.7 g H₂O was obtained and stirred adequately. The mixture of powder and solvent was performed at 24° C. The etching solution was aged for 2 hrs.

Glass Article A was subjected to the same treatment as Glass Article A in Comparative Example 1 prior to etching.

Prior to etching, Example Etchant G had been settled down for 300 s. Glass Article A was submerged and cycled in Example Etchant G for a period of 30 s and at a cycling speed of 4 cm/s. Glass Article A was then held stable (i.e., no cycling) in Example Etchant G for 30 s. The temperature of Example Etchant G was 12° C.

Etched Glass Article A was subjected to the same treatment as Glass Article A in Comparative Example 1 after etching.

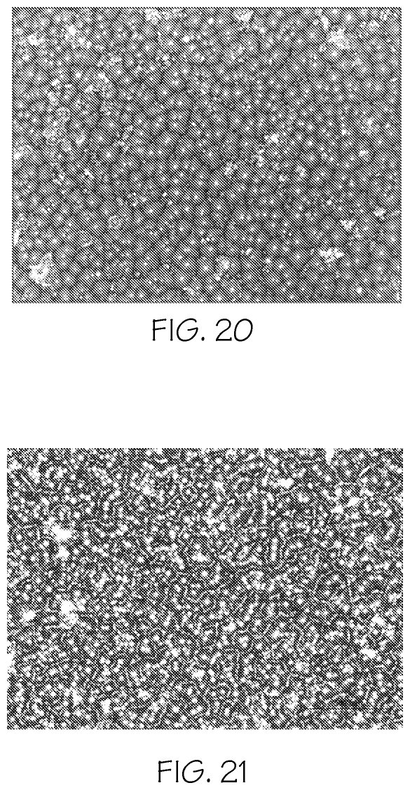

Referring now to FIG. 20, treating Glass Article A with Example Etchant G resulted in Example Textured Article H having sufficient coverage and micro-uniformity of the resulting polyhedral surface features. Example Textured Article H included triangular and quadrangular pyramids and had a surface feature size of 100 μm.

### Example 9—Example Textured Article I (Example Etchant H and Glass Article A)

To obtain Example Etchant H, blended powder including 89.7 g NH₄F, 3 g (NH)₂SiF₆, and 1.5 g PDADMAC was obtained by hand mill. Pre-mixed solvent including 167.08 g (96.5 wt %) H₂SO₄ and 238.7 g H₂O was obtained and stirred adequately. The mixture of powder and solvent was performed at 24° C. The etching solution was aged for 2 hrs.

Glass Article A was subjected to the same treatment as Glass Article A in Comparative Example 1 prior to etching.

Prior to etching, Example Etchant H had been settled down for 300 s. Glass Article A was submerged and cycled in Example Etchant H for a period of 30 s and at a cycling speed of 4 cm/s. Glass Article A was then held stable (i.e., no cycling) in Example Etchant H for 30 s. The temperature of Example Etchant H was 12° C.

Etched Glass Article A was subjected to the same treatment as Glass Article A in Comparative Example 1 after etching.

Referring now to FIG. 21, treating Glass Article A with Example Etchant H resulted in Example Textured Article I having sufficient coverage and micro-uniformity of the resulting polyhedral surface features. Example Textured Article I included triangular and quadrangular pyramids and had a surface feature size of 50 μm.

### Example 10—Example Textured Article J (Example Etchant I and Glass Article A)

To obtain Example Etchant I, blended powder including 89.7 g NH₄F, 3 g (NH)₂SiF₆, 10 g NaC₆H₁₁O₇, and 1.5 g PDADMAC was obtained by hand mill. Pre-mixed solvent including 167.08 g (96.5 wt %) H₂SO₄ and 238.7 g H₂O was obtained and stirred adequately. The mixture of powder and solvent was performed at 24° C. The etching solution was aged for 2 hrs.

Glass Article A was subjected to the same treatment as Glass Article A in Comparative Example 1 prior to etching.

Prior to etching, Example Etchant I had been settled down for 300 s. Glass Article A was submerged and cycled in Example Etchant I for a period of 30 s and at a cycling speed of 4 cm/s. Glass Article A was then held stable (i.e., no cycling) in Example Etchant I for 30 s. The temperature of Example Etchant I was 12° C.

Etched Glass Article A was subjected to the same treatment as Glass Article A in Comparative Example 1 after etching.

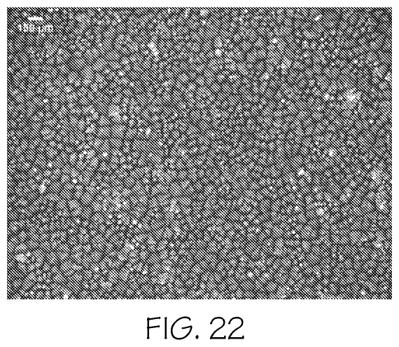

Referring now to FIG. 22, treating Glass Article A with Example Etchant I resulted in Example Textured Article J having sufficient coverage and micro-uniformity of the resulting polyhedral surface features. Example Textured Article J included triangular and quadrangular pyramids and had a surface feature size of 90 μm.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. An etchant comprising:
greater than or equal to 20 wt % and less than or equal to 45 wt % ammonium bifluoride;
greater than or equal to 0.25 wt % and less than or equal to 10 wt % of a silicon compound, the silicon compound comprising silica, silica gel, ammonium hexafluorosilicate, potassium hexafluorosilicate, sodium hexafluorosilicate, magnesium hexafluorosilicate, or a combination thereof;
greater than or equal to 5 wt % and less than or equal to 30 wt % hydrochloric acid;
greater than or equal to 25 wt % and less than or equal to 60 wt % water; and
greater than or equal to 0.5 wt % and less than or equal to 20 wt % of polyhydric alcohol.

2. The etchant of claim 1, wherein the polyhydric alcohol comprises pentaerythritol, ethylene glycol, 1,2-propanediol, 1,4-butanediol, 1,6-hexanediol, neopentyl glycol, diethylene glycol, dipropylene glycol, trimethylolpropane, glycerol, or a combination thereof.

3. The etchant of claim 1, wherein a weight ratio of a sum of the ammonium bifluoride and the silicon compound to a sum of the hydrochloric acid, the water, and the polyhydric alcohol is from 0.3 to 0.9.

4. The etchant of claim 1, wherein the etchant comprises greater than or equal to 0.5 wt % and less than or equal to 8 wt % of the silicon compound.

5. The etchant of claim 4, wherein the etchant comprises greater than or equal to 0.75 wt % and less than or equal to 6 wt % of the silicon compound.

6. The etchant of claim 1, wherein the etchant comprises greater than or equal to 1 wt % and less than or equal to 15 wt % polyhydric alcohol.

7. The etchant of claim 6, wherein the etchant comprises greater than or equal to 1.5 wt % and less than or equal to 10 wt % polyhydric alcohol.

8. The etchant of claim 1, wherein the etchant comprises greater than or equal to 23 wt % and less than or equal to 43 wt % ammonium bifluoride.

9. The etchant of claim 8, wherein the etchant comprises greater than or equal to 25 wt % and less than or equal to 40 wt % ammonium bifluoride.

10. The etchant of claim 1, wherein the etchant comprises greater than or equal to 7 wt % and less than or equal to 27 wt % hydrochloric acid.

11. The etchant of claim 10, wherein the etchant comprises greater than or equal to 10 wt % and less than or equal to 25 wt % hydrochloric acid.

12. The etchant of claim 1, wherein the etchant comprises greater than or equal to 30 wt % and less than or equal to 55 wt % water.

13. The etchant of claim 1, wherein the etchant comprises:
greater than or equal to 25 wt % and less than or equal to 40 wt % ammonium bifluoride;
greater than or equal to 0.5 wt % and less than or equal to 4 wt % silica gel;
greater than or equal to 13 wt % and less than or equal to 23 wt % hydrochloric acid;
greater than or equal to 35 wt % and less than or equal to 55 wt % water; and
greater than or equal to 1 wt % and less than or equal to 15 wt % glycerol.

14. The etchant of claim 1, wherein the etchant further comprises greater than or equal to 3 wt % and less than or equal to 30 wt % ammonium fluoride.

15. The etchant of claim 1, wherein the etchant further comprises greater than or equal to 0.25 wt % and less than or equal to 20 wt % of at least one of a sodium salt of a potassium salt.

16. A method of forming a textured glass article, the method comprises:
submerging an aluminosilicate glass article in an etchant, the etchant comprising:
greater than or equal to 20 wt % and less than or equal to 45 wt % ammonium bifluoride;
greater than or equal to 0.25 wt % and less than or equal to 10 wt % of silicon compound, the silicon compound comprising silica, silica gel, ammonium hexafluorosilicate, potassium hexafluorosilicate, sodium hexafluorosilicate, magnesium hexafluorosilicate, or a combination thereof;
greater than or equal to 5 wt % and less than or equal to 30 wt % hydrochloric acid;
greater than or equal to 25 wt % and less than or equal to 60 wt % water; and
greater than or equal to 0.5 wt % and less than or equal to 20 wt % of polyhydric alcohol; and
cycling the aluminosilicate glass article in the etchant between an upper submerging depth and a lower submerging depth deeper than the upper submerging depth for a cycling time.

17. An etchant comprising:
greater than or equal to 3 wt % and less than or equal to 30 wt % ammonium fluoride;
greater than or equal to 0.25 wt % and less than or equal to 10 wt % of a silicon compound, the silicon compound comprising silica, silica gel, ammonium hexafluorosilicate, potassium hexafluorosilicate, sodium hexafluorosilicate, magnesium hexafluorosilicate, or a combination thereof;
greater than or equal to 15 wt % and less than or equal to 45 wt % sulfuric acid;
greater than or equal to 25 wt % and less than or equal to 60 wt % water; and
greater than or equal to 0.1 wt % and less than or equal to 10 wt % of a viscosity additive.

18. The etchant of claim 17, wherein the viscosity additive comprises sugar, metal gluconate, polydiallydimethylammonium chloride (PDADMAC), or a combination thereof.

19. The etchant of claim 17, wherein the etchant comprises greater than or equal to 0.25 wt % and less than or equal to 8 wt % silicon compound.

20. A method of forming a textured glass article, the method comprises:
submerging an aluminosilicate glass article in an etchant, the etchant comprising:
greater than or equal to 3 wt % and less than or equal to 30 wt % ammonium fluoride;
greater than or equal to 0.25 wt % and less than or equal to 10 wt % of a silicon compound, the silicon compound comprising silica, silica gel, ammonium hexafluorosilicate, potassium hexafluorosilicate, sodium hexafluorosilicate, magnesium hexafluorosilicate, or a combination thereof;
greater than or equal to 15 wt % and less than or equal to 45 wt % sulfuric acid;
greater than or equal to 25 wt % and less than or equal to 60 wt % water; and
greater than or equal to 0.1 wt % and less than or equal to 10 wt % of a viscosity additive; and
cycling the aluminosilicate glass article in the etchant between an upper submerging depth and a lower submerging depth deeper than the upper submerging depth for a cycling time.
